(19) United States
(12) Patent Application Publication
(10) Pub. No.: US 2026/0310462 A1
(43) Pub. Date: Oct. 8, 2026

(54) PROVIDING DOCUMENTATION-BASED SOFTWARE SUPPORT SERVICES

(71) Applicant: Dell Products L.P., Round Rock, TX (US)

(72) Inventors: SHELLY GOLDBLIT, Haifa (IL); REUT KOVETZ, Tel Aviv (IL); OFIR EZRIELEV, Be'er Sheva (IL); NISREEN AWAD, Nazareth (IL); JEHUDA SHEMER, Kfar Saba (IL); HAREL MAZOR, Ramot Menashe (IL)

(21) Appl. No.: 19/173,455

(22) Filed: Apr. 8, 2025

(51) Int. Cl. G06F 8/73

(52) U.S. Cl. CPC G06F 8/73

(57) ABSTRACT

Methods and systems for providing computer-implemented services using software are disclosed. A request indicating a goal of a user of an instance of the software that the user is unable to accomplish may be obtained. Based on the request, a portion of documentation for the instance of the software may be identified. Based on the portion of the documentation, a set of operations that must be performed to accomplish the goal may be identified. Based on the set of operations and a state of the instance of the software, instructions to entice the user to perform at least a portion of the set of operations to facilitate accomplishment of the goal may be iteratively provided.

### FIELD

Embodiments disclosed herein relate generally to providing computer-implemented services using software. More particularly, embodiments disclosed herein relate to systems and methods for providing support services for use of the software.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIGS. 2A-2G show data flow diagrams in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing documentation for software used to provide computer-implemented services. For example, downstream consumers of the computer-implemented services may interact with the software hosted by systems to activate features and/or functionality of the software in order obtain the computer-implemented services.

To obtain desired computer-implemented services, the downstream consumers, such as users of the software, may rely on software documentation (e.g., user manuals and/or other types of documents that include information regarding the features and/or functionality of the software) for guidance in achieving desired outcomes that lead to obtaining the desired computer-implemented services while using the software. For example, without adequate software documentation, a downstream consumer may be unable to obtain the desired computer-implemented services.

However, provisioning of adequate documentation to the downstream consumers in a timely manner may present challenges with respect to resource costs and time limitations. For example, generation of the documentation may require the manual identification, collection, and/or organization of content usable to generate the documentation, as well as orchestrated manual efforts by subject matter experts. Provisioning of the documentation may be further constrained by deadlines (e.g., software testing deadlines, software deployment deadlines).

To manage the limited resources and the time constraints, generic documentation may be provided to all users of the software, regardless of variations in use cases for the software. For example, the use cases may depend based on capabilities of systems hosting the software and/or objectives of users of the software. However, due to the variations in use cases for the software, the generic documentation may be inadequate for facilitating desired computer-implemented services via the software.

For example, a user may be unable to accomplish a goal while using an instance of the software. The user may have difficulty finding and following information in the generic documentation due to information bloat (e.g., an overabundance of information regarding a variety of use cases), information relevancy issues (e.g., a lack of information relevant to a use case of the user), and/or information congruency issues (e.g., examples provided in the generic documentation may not match the user’s experience while the user interacts with the software). Therefore, the user may be unable to accomplish the goal and/or may otherwise be unable to operate the software in a manner that facilitates the desired computer-implemented services.

Thus, to increase a likelihood of facilitating the desired computer-implemented services, the user may be provided with automated interactive support upon request. For example, the user may request assistance in accomplishing the goal, and instructions (e.g., computer instructions) to entice the user to perform a set of operations to accomplish the goal may be automatically provided to the host system. The instructions may be obtained using documentation for the instance of the software.

The documentation for the instance of the software may include documentation customized to the host system; therefore, information included in the customized documentation may be likely to be relevant to the use case for the user, and likely to be congruent with the user’s experience while interacting with the software.

To manage limited resources and/or time constraints for generating the customized documentation, the customized documentation may be generated automatically based on pre-existing data used during development of the software. Available content of the pre-existing data may be automatically identified, extracted, and used to populate portions of dynamically defined document structures to obtain different types of software documentation. To customize the documentation, only available content relevant to the use case (e.g., use of the instance of the software) may be used to populate the document structures and/or to define the document structures.

The automated interactive support services may include walking the user through operations for accomplishing the goal by iteratively providing the instructions to the host system, and/or automatically invoking functionality of the host system to perform operations on behalf of the user to accomplish the goal.

By doing so, time and manual effort associated with provisioning (e.g., preparing, supplying, delivering) of software documentation to users of the software may be decreased, and the users may be more likely to accomplish their goals while using the software than when relying on generic documentation and/or manual interactive support that may be unreliable or delayed.

In an embodiment, a method for providing computer-implemented services using software is provided. The method may include: obtaining a request, the request indicating a goal of a user of an instance of the software that the user is unable to accomplish; identifying, based at least on the request, a portion of documentation for the instance of the software; identifying, based on the portion of the documentation, a set of operations that must be performed to accomplish the goal; and, iteratively providing, based on the set of operations and a state of the instance of the software, instructions to entice the user to perform at least a portion of the set of operations to facilitate accomplishment of the goal.

Identifying the portion of the documentation may include: automatically identifying a system hosting the instance of the software based on a connection between the system and a backend service adapted to support the user in accomplishing the goal; and, identifying the documentation based on the system.

Identifying the portion of the documentation may further include: obtaining identifiers based at least on the goal, the identifiers indicating at least one feature of the software; and, using the identifiers to identify the portion of the documentation.

Identifying the documentation may include at least one selected from a list consisting of: dynamically generating the documentation; and, obtaining previously generated documentation, the previously generated documentation being generated prior to obtaining the request.

Dynamically generating the documentation may include: identifying software development elements used to produce the software; identifying available content from the software development elements; identifying a structure based at least on the available content; and, automatically generating the documentation using the structure and the available content.

The software development elements may include: software development goal information; production code for the software; code development organizational information; test code used to test the software; test plans defining how the software is to be tested; artifacts produced during testing of the software using the test code and the test plans; and, software product integrated organizational information.

Iteratively providing the instructions may include: obtaining a first state for the instance of the software, the first state indicating that a first operation of the set of operations has been performed by the user; identifying a second operation of the set of operations based on the first operation; and, providing a second instruction of the instructions to entice the user to perform the second operation.

The second instruction may include at least one of a group consisting of: modifying an appearance of a user interface element of a user interface of the instance of the software presented to the user of the instance of the software to draw attention of the user to the user interface element; adding an information element to the user interface to contextualize a function of the user interface element for the user; and, activating the function on behalf of the user.

Iteratively providing the instructions may include automatically invoking functionality of a system hosting the instance of the software to cause the set of operations to be completed.

A non-transitory media may include computer instructions that when executed by a processor cause the computer-implemented method to be performed.

A data processing system may include the non-transitory media and a processor, and may perform the computer-implemented method when the computer instructions are executed by the processor.

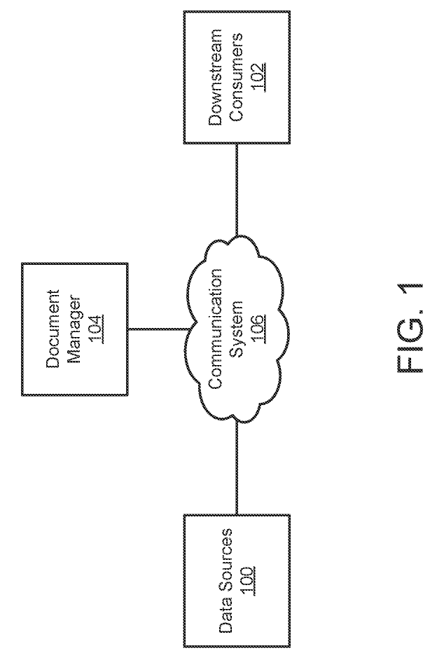

Turning to FIG. 1, a block diagram illustrating a distributed system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device.

The computer-implemented services may be provided by a system. The system may include a deployment of one or more data processing systems and/or other components, and the deployment may be designed and/or configured to meet an objective. For example, the objective may include providing a specific computer-implemented service in a desired manner. Thus, software that facilitates computer-implemented services may be hosted by different types of systems in order to meet different objectives of downstream consumers of the computer-implemented services.

For example, the downstream consumers may include users of the system, and the users may operate (e.g., interact with) at least a portion of the system that hosts the software to obtain computer-implemented services. To obtain desired (e.g., expected) computer-implemented services, the users may rely on documentation (e.g., user manuals, troubleshooting instructions, a list of frequently asked questions, administrator guides, videos, walkthroughs, tutorials, etc.) as a guide for operating software components of the data processing systems. Without the documentation, for example, the users of the data processing systems may be unable to access desired features and/or functionality of the software, and/or may otherwise be unable to interact with the software in a manner that is likely to provide the desired computer-implemented services.

To increase a likelihood of the downstream consumers obtaining the desired computer-implemented services via the software, documentation for the software may be provided to the downstream consumers. However, due to limited resources (e.g., time, manual effort, cost) required to generate the documentation, the documentation may be inadequate for facilitating provisioning of the desired computer-implemented services. For example, to manage the limited resources, a generic version of the documentation may be provided to all downstream consumers (e.g., users of the software) despite differences in factors that relate to use of the software.

For example, differences in systems (e.g., hardware components, software components, and/or configuration settings of the systems) that host the software may impact capabilities of the systems to support advanced features of the software, and/or different users of the systems may have different objectives for use of the software that may impact the activation and deactivation of some features of the software.

In other words, different features of the software may be available for use by a user of a system depending on a use case for the software. Thus, due to a variation in use cases of the software, the generic documentation may include large volumes of information irrelevant to a use case (e.g., the generic documentation may be subject to information bloat) and/or the generic documentation may lack uncommon but relevant information to the use case.

For example, the generic documentation may include examples of workflows that may be performed by a user of the software. The examples may include human interpretable instructions, such as text and images of a user interface of the software at various steps of the workflow. However, the examples may not be congruent with a user interface of an instance of the software as presented to the user, for example, depending on the system hosting the instance of the software, the configuration settings of the instance of the software, and/or user data impacting the instance of the software.

Therefore, when referencing the generic documentation, the user may have difficulty finding relevant information timely, may be confused by irrelevant information, and/or may be unable to follow the example workflows. As a result, the user may be unable to interact with the software in a desired manner, and therefore may not be provided with the desired computer-implemented services.

In general, embodiments disclosed herein may provide methods, systems, and/or devices for providing computer-implemented services using software in a manner that is more likely to result in timely provisioning of desired computer-implemented services. To do so, documentation for the software may be generated automatically based on pre-existing portions of information used during development of the software and a dynamically defined document structure.

For example, available content may be identified from software development elements such as test code, test plans, test run artifacts, production code, etc. used to produce the software. The available content may be extracted and transformed to populate the dynamically defined document structure in order to obtain various types of software documentation. By generating the documentation automatically based on pre-existing information, manual efforts and time required to generate the documentation may be reduced, and the automated efforts may be used to generate customized documentation.

To improve a level of relevancy of the documentation with respect to a use case for the software, the documentation may be automatically customized based on characteristics of use of the software such as a type of system hosting the software and/or other information. For example, a system type for the system may be identified based on types and quantities of hardware components and software components of the system, and/or configuration settings of the system. Relevant flow data indicating features of the software that are likely to be available for use by a user of the system (e.g., features likely to be supported by the system type) may be obtained.

The relevant flow data may be used to identify portions of available content from the software development elements that are most likely to be relevant to the use case for the software (e.g., relevant to use of the software in view of the system and the user), and/or to dynamically define the document structure to support the customization of the documentation. By automatically generating the customized documentation, information included in the documentation may be more likely to relevant to the use case.

To increase a likelihood of providing desired computer-implemented services to the users of the software, the documentation (e.g., the customized documentation) may be used to provide automated interactive user support. For example, when a user of an instance of the software provides a request for support in accomplishing a goal using the instance of the software, a set of operations that must be performed to accomplish the goal may be identified from the documentation. A set of instructions (e.g., computer instructions) may be provided to a system hosting the instance of the software to entice the user to perform the set of operations (or a portion thereof).

For example, the interactive user support may include step-by-step interactive support (e.g., “walk me through it” support) where the system is provided portions of the instructions in an iterative manner, and/or complete interactive support (e.g., “do it for me” support), where the instructions are used to automatically invoke functionality of the system.

By using (customized) documentation to provide automated interactive support services to users of instances of the software, the users may be more likely to accomplish their goals in a timely manner than when using manual interactive support methods (e.g., phone, email, and/or live chat using customer service agents), which may be unreliable and/or delayed. As a result, the users (e.g., downstream consumers of the computer-implemented services) may be more likely to be provided with the desired computer-implemented services.

To provide the above-mentioned functionality, the distributed system of FIG. 1 may include data sources 100, downstream consumers 102, document manager 104, and communication system 106. The distributed system, any components thereof, and/or any other types of devices or components not shown in FIG. 1 may perform all, or a portion of the computer-implemented services independently and/or cooperatively. Each of these components is discussed below.

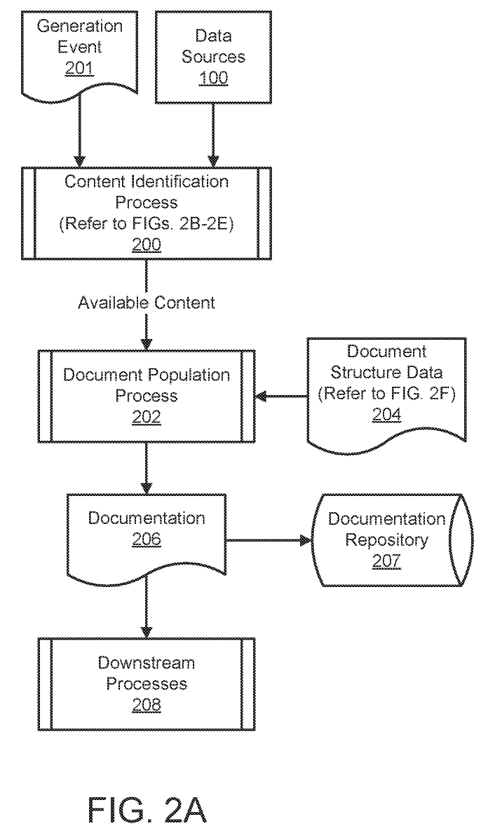

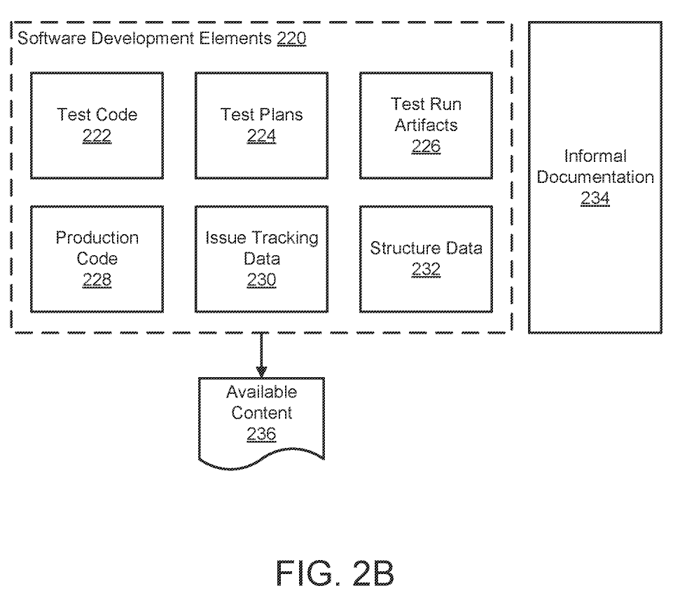

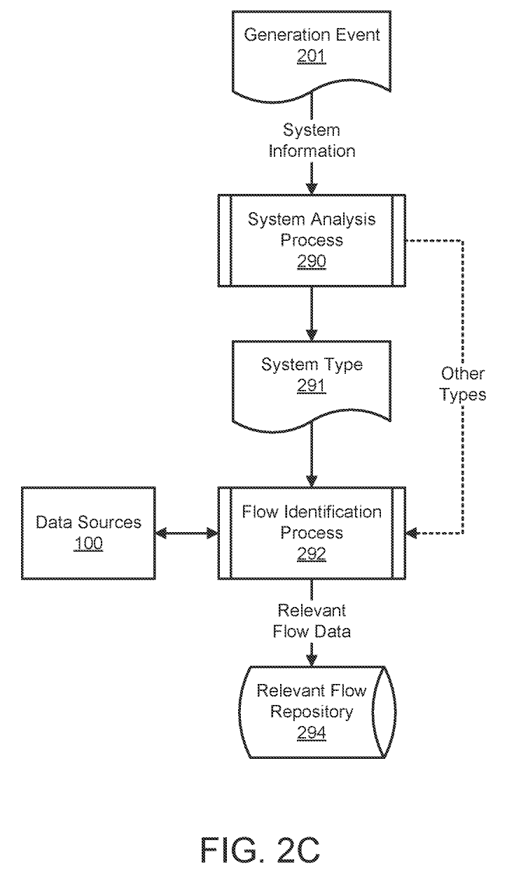

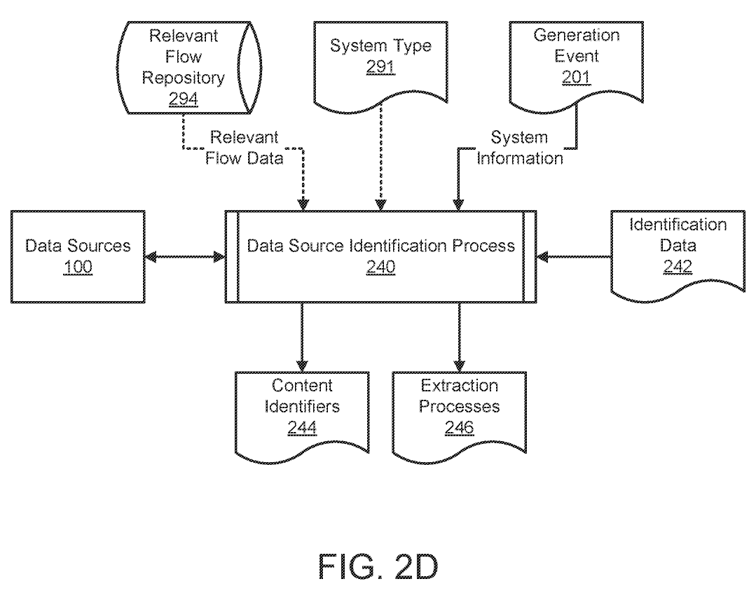

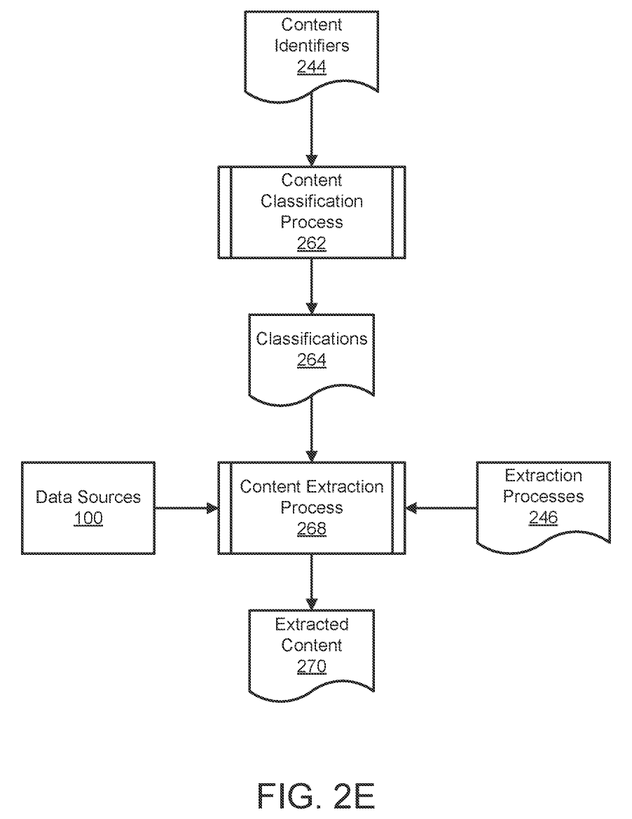

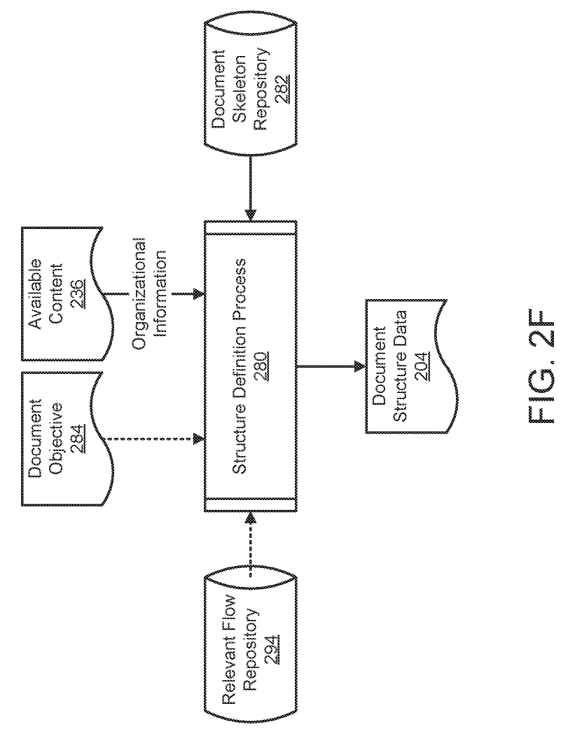

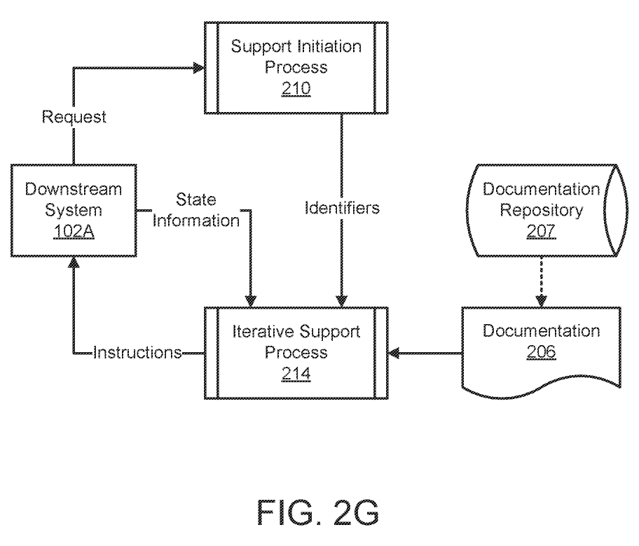

Data sources 100 may include any type and/or number of data sources. Each of data sources 100 may include hardware and/or software components configured to obtain data, store data, provide data to other entities (e.g., document manager 104), and/or to perform any other tasks related to facilitating performance of computer-implemented services. Data sources 100 may include data repositories and/or portions of data (e.g., files, pieces of files). For example, data sources 100 may include information generated during production of and/or used to produce software used by downstream consumers 102 (e.g., software development elements and/or other information). Refer to the discussion of FIG. 2B for more details regarding data sources 100.

Downstream consumers 102 may include any number and/or type of downstream consumers. For example, downstream consumers 102 may include individuals (e.g., users of data processing systems, administrators of data processing systems), organizations, and/or computers. Downstream consumers 102 may consume all, or a portion of the computer-implemented services. Downstream consumers 102 may use software to obtain computer-implemented services. For example, downstream consumers 102 may include systems that host the software such as downstream system 102A of FIG. 2G, and/or users of the systems that host the software.

Downstream consumers 102 may include different types of users of different types of systems that host the software. Therefore, downstream consumers 102 may rely on customized documentation and/or customized user support in order to obtain desired computer-implemented services. Documentation and documentation-based support services for the software may be managed by document manager 104.

Document manager 104 may include any number of data processing systems and may manage any volume of documentation for any number and/or type of software. Document manager 104 may perform tasks related to the generation, management, and/or provisioning of software documentation, including customized documentation. Document manager 104 may participate in downstream processes during which the documentation is provided to and/or used by downstream consumers 102.

For example, document manager 104 may provide support services to downstream consumers 102 based on customized documentation. To do so, document manager 104 may host a service (e.g., a backend service) adapted to support users of the software while operating instances of the software. The support services provided by document manager 104 may include automated interactive support services, provided based on documentation. Refer to the discussion of FIG. 2G for more information regarding providing documentation-based support services for downstream consumers 102.

To manage the documentation, document manager 104 may make identifications of occurrences of documentation generation events for the software. For example, a documentation generation event may be triggered manually or automatically at a certain phase in a development lifecycle of the software. The occurrence of the documentation generation event may indicate, for example, information usable to identify a system hosting an instance of the software and/or other information usable for generating fit for purpose (e.g., customized) documentation.

Document manager 104 may dynamically generate documentation (e.g., based on identifications of occurrences of documentation generation events). For example, to dynamically generate the documentation, document manager 104 may (i) identify software development elements used to produce the software, (ii) identify available content from the software development elements, (iii) identify a structure based at least on the available content, (iv) automatically generate the documentation using the structure and the available content, and/or (v) perform other actions relating to generation and/or management of documentation (e.g., provide the documentation to a repository for storage). Refer to the discussion of FIG. 2A for more information regarding automatic generation of software documentation using software development elements.

The software development elements may be a portion of information used (e.g., generated) during various phases in a development lifecycle for the software. For example, the software development elements may include (i) software development goal information, (ii) production code for the software, (iii) code development organizational information, (iv) test code used to test the software, (v) test plans defining how the software is to be tested, (vi) artifacts produced during testing of the software using the test code and the test plans, (vii) software product integrated organizational information, (viii) other types of software development elements, and/or (ix) combinations thereof. Refer to FIG. 2B for more details regarding software development elements.

To customize the documentation, document manager 104 may obtain relevant flow data. For example, when customizing the documentation to a system hosting an instance of the software, the relevant flow data may be obtained based on a system type of the host system. Document manager 104 may use the system type and/or other information to identify software workflows (e.g., features of the software) that are likely to be available for use by a user of the system. For example, the system type may be associated with capabilities of the system with respect to the software. The relevant flow data may be usable to obtain (e.g., select, generate) portions of available content of the software development elements relevant to the system type (e.g., relevant to use of the software in view of the system type). Refer to FIG. 2C for more details regarding obtaining relevant flow data.

To identify the software development elements used to produce the software, document manager 104 may (i) obtain identification data (e.g., using a manual or automated process) usable to identify at least a portion of the software development elements, (ii) use the identification data to obtain content identifiers indicating storage locations of information usable to obtain available content from the software development elements, and/or (iii) identify extraction processes for obtaining the available content indicated by the content identifiers. When the documentation is customized to the system hosting (an instance of) the software, the relevant flow data may be used to constrain the available content indicated by the content identifiers to a portion of the available content relevant to the system type. Refer to FIG. 2D for more details regarding identification of the software development elements.

To identify and/or obtain the available content from the software development elements, document manager 104 may (i) obtain classifications for portions of the software development elements (e.g., using the content identifiers), (ii) identify, based on the classifications, at least one extraction process to obtain the available content stored by the software development elements, and/or (iii) perform the at least one extraction process to obtain the available content. Therefore, when relevant flow data is used to define the content identifiers, only the portion of the available content relevant to the system type may be obtained. Refer to FIG. 2E for more details regarding extraction of available content from the software development elements.

To identify the structure for the documentation, document manager 104 may (i) discriminate between portions of the available content to identify a first portion of the available content that is classified as organizational information (e.g., from a remaining portion of the available content that is classified as actionable information), and/or (ii) use the first portion of the available content, and/or other information (e.g., a document objective) to dynamically define the structure for the documentation. For example, when the documentation is customized to the system hosting (an instance of) the software, the structure may be dynamically defined based on organizational information of the portion of the available content relevant to the system type and the relevant flow data. Refer to FIG. 2F for more details regarding dynamic definition of structures for software documentation.

To provide support services to downstream consumers 102 (e.g., users of the software), document manager 104 may (i) obtain a request (e.g., a request for support) indicating a goal of a user of the software that the user is unable to accomplish, (ii) identify a portion of documentation for the instance of the software (e.g., based on the request), (iii) identify a set of operations that must be performed to accomplish the goal (e.g., based on the portion of the documentation, (iv) obtain state information for the system, and/or (v) iteratively provide instructions (e.g., computer instructions, to the host system) to entice the user to perform at least a portion of the set of operations to facilitate accomplishment of the goal (e.g., based on the state information).

Document manager 104 may include functionality for automatically identifying (i) the host system, and/or (ii) an instance of the software hosted by the host system, based on information in the request. Based on the identified host system and/or the identified instance of the software, document manager 104 may identify documentation customized to a use case for the software (e.g., customized to the system and/or the instance of the software). For example, to identify the customized documentation, document manager 104 may dynamically generate the customized documentation and/or obtain previously generated customized documentation (e.g., from a repository). Refer to the discussion of FIG. 2G for more information regarding providing support services using the documentation.

Document manager 104 may perform any and/or all of the above-mentioned functionality automatically to reduce manual efforts and delays with respect to provisioning of software documentation to downstream consumers 102 and with respect to providing support services for downstream consumers 102.

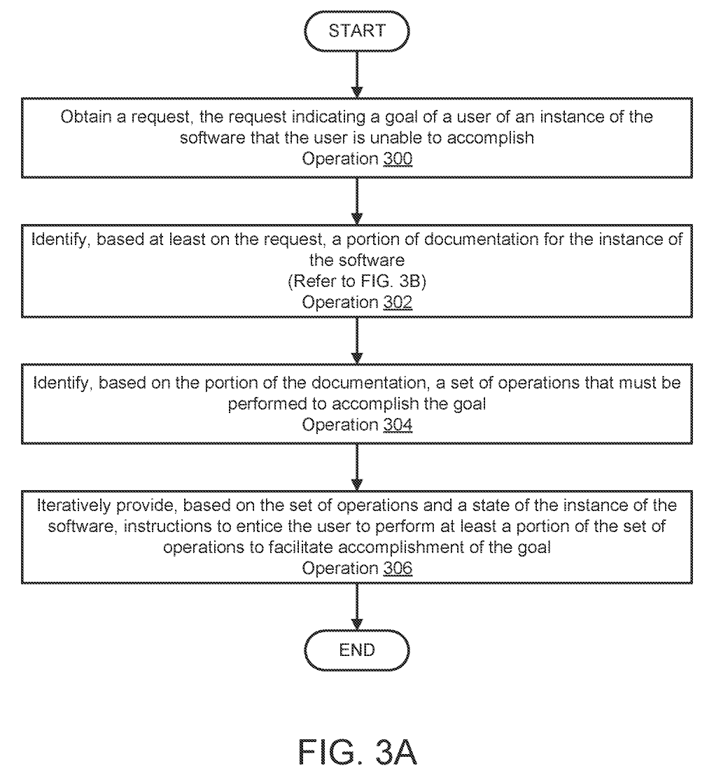

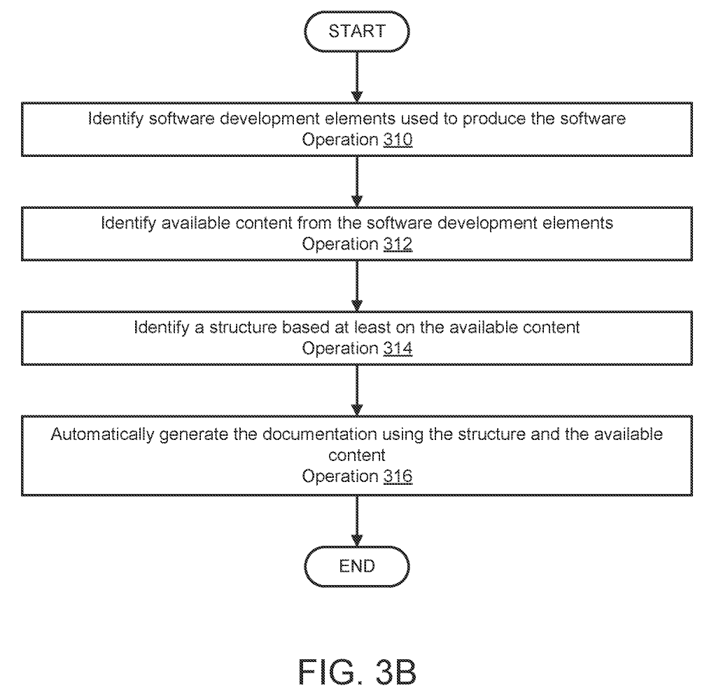

When providing their functionality, any of data sources 100, downstream consumers 102, document manager 104, and/or components thereof may perform all, or a portion of the actions and methods illustrated in FIGS. 2A-3B.

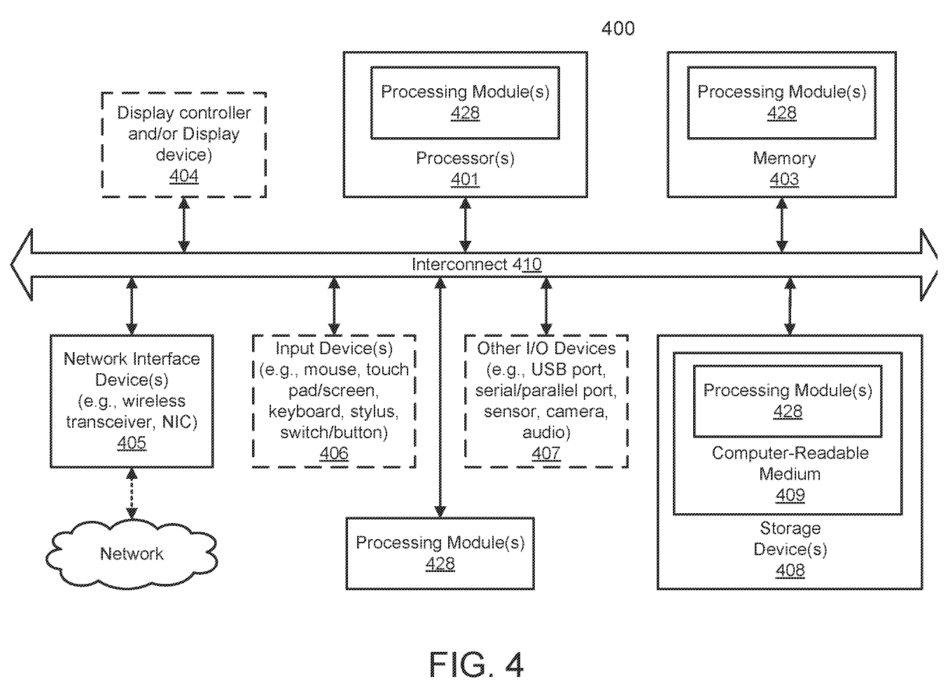

Any of data sources 100, downstream consumers 102, and document manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2G. In the diagrams, flows of data and processing of data are illustrated using different sets of shapes. A first set of shapes (e.g., 201, 204) is used to represent data structures, a second set of shapes (e.g., 200, 202) is used to represent processes performed using and/or that generate data, a third set of shapes (e.g., 207, 282) is used to represent data repositories, and a fourth set of shapes (e.g., 100, 220) is used to represent sources of data.

Turning to FIG. 2A, a first data flow diagram in accordance with an embodiment is shown. The first data flow diagram may illustrate data used in and data processing performed during management of documentation for software used to provide computer-implemented services. The documentation may include customized documentation, and the documentation may be customized to a use case for the software (e.g., customized to a system hosting an instance of the software).

To manage the documentation, available content from data sources 100 may be obtained during content identification process 200. Content identification process 200 may be initiated based on an occurrence of a documentation generation event for the software. For example, the documentation generation event may include (i) installation of the software to a system, (ii) execution of the software by a system, (iii) establishing a connection between a system hosting the software and a management entity of the documentation (e.g., document manager 104), (iv) performance of a user action that triggers a documentation generation policy (e.g., a member of a development team for the software creating a testing directory, a user of the software activating a help feature of the software), and/or (iv) other events related to development and/or use of the software.

During and/or as a result of the documentation generation event, a data structure such as generation event 201 may be obtained. For example, generation event 201 may include a notification or request provided by an individual, a computer, another entity, and/or other types of data structures that may be automatically generated based on occurrences of documentation generation events.

For example, generation event 201 may include a data structure that is generated automatically during a phase of a development cycle for the software. A management entity (e.g., document manager 104) may identify that generation event 201 has been obtained (.g., generated) and may provide generation event 201 to content identification process 200. Generation event 201 may include (i) information usable to identify the software (e.g., the instance of the software) such as a software identifier, (ii) information usable to identify a system hosting the software (e.g., the instance of the software) such as a system identifier, (iii) a document objective (e.g., user information, system information, a document type), and/or (iv) other information regarding the documentation.

Portions of the information included in generation event 201 may be obtained from (i) the user of the system, and/or (ii) another entity (e.g., an automated system, an administrator) that may be responsible for initiating generation of the documentation.

Generation event 201 may include user information such as characteristics of the user of the system (e.g., job title of the user, a knowledge level of the user, a level of proficiency in the software of the user, an access level associated with the user, a domain of expertise of the user, an age of the user, a gender of the user, a culture of the user, and/or other user demographic information usable to obtain a user type). Generation event 201 may include system information indicating, for example, (i) a type and/or quantity of hardware components of the system, (ii) software components of the system, (iii) configuration settings for the system, (iv) software information (e.g., a software version, configuration settings of the software) and/or (v) other information usable to characterize and/or typify the system with respect to the software (e.g., obtain a system type). Refer to FIG. 2C for more information regarding identifying a system type.

Content identification process 200 may be performed based on the occurrence of the documentation generation event (e.g., based on information included in generation event 201). During content identification process 200, to obtain content for generating documentation 206, a portion of information used during development of the software may be identified from data sources 100. FIG. 2B illustrates an example of data sources 100.

Turning to FIG. 2B, a second data flow diagram in accordance with an embodiment is shown. The second data flow diagram may illustrate information used during various phases of development of software. For example, FIG. 2B may illustrate different types of development artifacts that may be generated during development of the software.

The information may include software development elements 220 and/or informal documentation 234. Software development elements 220 may include test code 222 (e.g., test code used to test the software), test plans 224 (e.g., test plans defining how the software is to be tested), test run artifacts 226 (e.g., artifacts produced during testing of the software using the test code and the test plans), production code 228 (e.g., production code for the software), issue tracking data 230 (e.g., software development goal information), structure data 232 (e.g., code development organizational information, software product integrated organizational information), and/or other information (not shown). For example, software development elements 220 may include a data repository, a directory (e.g., a testing directory), groups of files (e.g., testing documentation within a directory), a file (e.g., an image, a video), and/or portions of files (e.g., portions of test code).

Informal documentation 234 may include any type and/or quantity of informal documentation for software development elements 220, such as developer notes (e.g., readme files), presentations, emails, messages, and/or other information. Information included in informal documentation 234 may not be suitable for use in generating software documentation. For example, informal documentation 234 may include information that is partially incomplete and/or inaccurate with respect to a source of truth (e.g., software development elements 220), and/or informal documentation 234 may include developer interpretations for software development elements 220 that may be uninterpretable by entities outside of a target audience. For example, portions of informal documentation 234 may only be interpretable by software developers due to levels of technicality and/or levels of specificity of the information.

Thus, informal documentation 234 may include information that is not suitable for use in provisioning of the software documentation. However, software development elements 220 may be considered a source of truth, and therefore may include information suitable for use in generating the software documentation. Each of software development elements 220 shown in FIG. 2B is discussed below.

Test code 222 may include different types of test code. For example, test code 222 may include (i) system level test code (e.g., end-to-end level test code, test code usable to automate manual testing that may be performed by a quality assurance engineer), (ii) unit level test code (e.g., test code usable to test an isolated unit of code that supports a single function within the software application with respect to expected behavior), (iii) component level test code (e.g., test code usable to test an isolated component of the software, such as a user interface component), (iv) integration test code (e.g., test code usable to test interactions between parts of the system and emulated parts of the system), and/or (v) combinations thereof.

The different types of test code may include information usable to identify product flows (e.g., tests with positive outcomes), negative tests (e.g., tests with negative outcomes), and/or other information usable to generate software documentation. For example, during software testing, portions of the different types of test code may be executed to obtain images and/or videos that depict use of various features and/or functionality of the software.

For example, the test code may be executed to simulate a flow (e.g., workflow) that is likely to be performed by a user of the software. During the simulation, activity and/or output of the software may be obtained (e.g., the user interface of the software may be recorded and/or otherwise captured). The activity and/or output of the software may include visual information such as images (e.g., screenshots, sequences thereof) and video.

In some examples, the recorded activity and/or output of the software may be processed to improve its interpretability by and/or presentation to the user. In a first example, the test code may be designed to simulate the user flow at high speeds; therefore, videos captured during the simulation may be slowed to speeds fit for human consumption (e.g., walkthrough videos may be slowed more than demonstration videos). Other types of processing of the recorded activity and/or output may be performed. For example, a screenshot of the user interface of the application may be cropped, and text and/or objects may be added to the image to draw user attention to a specific portion of the user interface.

Test code 222 may include test initialization information, assertions used during testing, names of tests (e.g., file names), and/or other information (e.g., code comments that may indicate features and/or functionality being tested). For example, test names and test assertions may be used to identify desired paths of execution (e.g., good paths), undesired paths of execution (e.g., bad paths), workflow steps, preconditions for successfully performing workflows, and/or expected system behavior; and test initialization information may be used to identify system prerequisites and/or steps (e.g., actions) required prior to performing workflows.

Test plans 224 may include any quantity and/or type of test plans. Test plans 224 may include testing schemas used to define the test plans. For example, test plans 224 may include lists of features, functions, and/or workflows to be tested; therefore, information included in test plans 224 may be used to identify main topics and/or to explain workflows.

Test run artifacts 226 may include test reports, test logs, and/or other information produced during testing of the software (e.g., information generated as a result of executing portions of test code 222 and/or as a result of completing portions of test plans 224). For example, test run artifacts 226 may indicate and/or include information regarding successful or unsuccessful test results, video, images, and/or error information.

Production code 228 may include any quantity of code (and/or portions thereof) designed to run on production servers and/or other devices, such as in a browser or a desktop application running on a user device (e.g., client-side code). For example, production code 228 may include information regarding public application programming interfaces (APIs) for the software and/or information regarding intended features and/or functions of the software (e.g., code comments).

Issue tracking data 230 may include any quantity and/or type of data from an issue tracking system (e.g., Jira, GitHub, Azure). For example, issue tracking data 230 may include information regarding software development goals such as epics (e.g., large bodies of performance-related work for a release of the software), user stories (e.g., requirements or feature requests for the software generated from a perspective of the user or downstream consumer), acceptance criteria, known issues (e.g., bugs).

Structure data 232 may include any quantity and/or type of organizational information associated with development of the software. Structure data 232 may include code development organizational information, such as directory (and/or file) hierarchies used to organize portions of the production code and/or portions of the test code during development of the software. For example, code development organizational information may include directory structures, directory names, file names, and/or other storage structural information such as storage (e.g., organizational) relationships between the files and the directories.

Structure data 232 may include software product integrated organizational information such as a user interface menu (e.g., for a graphical user interface, for a command line interface). For example, structure data 232 may include information regarding a structure of the user interface menu such as an arrangement of options and/or commands included in the menu, their relationships and/or dependencies, images (e.g., snapshots of different screens and/or pages of the user interface, icons associated with each menu option and/or command), etc.

Thus, based on the information included in each of software development elements 220, a portion of information used during development of the software may be used to obtain available content 236. Available content 236 may be a portion of the available content stored by software development elements 220. For example, available content 236 may be the portion of the available content relevant to features of the software likely to be accessed by and/or available to a user of a system hosting the software. In other words, available content 236 may be constrained based on relevant flow data for a system type and/or a user type, and therefore may include a portion of pre-existing information usable to automatically generate documentation for the software.

Turning to FIG. 2C, a third data flow diagram in accordance with an embodiment is shown. The third data flow diagram may illustrate data used in and data processing performed when obtaining relevant flow data. For example, the relevant flow data may indicate features of software that are likely to be available to a user of a system hosting the software.

Any of the processes described with respect to FIG. 2C may, for example, be performed prior to an identification of an occurrence of a documentation generation event being made and/or prior to identifying available content (e.g., available content 236) from the software development elements based on the identification of the occurrence of the documentation generation event.

The relevant flow data may be obtained based on the identification of the occurrence of the documentation generation event. For example, the relevant flow data may be obtained based on a system type for the system hosting the software. As discussed, the occurrence of the documentation generation event may indicate system information (e.g., information regarding the system hosting the software, information regarding the software), user information (e.g., information regarding a user of the system), and/or other information.

As discussed with respect to FIG. 2A, generation event 201 may include system information such as (i) hardware component information, (ii) software component information (e.g., information regarding types of software hosted by and/or accessible via the hardware components of the system), (iii) information regarding configurable settings of the system, (iv) information regarding an objective of the system, and/or (v) other information usable to characterize the system. The system information may include information regarding an instance of the software hosted by the system, such as a version of the instance of the software and/or configuration settings of the instance of the software.

For example, the system information may include information regarding quantities and/or types of computer hardware included in each data processing system of a deployment such as processing components, memory components, storage components, network components, power supply components, cooling components, etc., and/or other information regarding the infrastructure of the system. The system information may be provided to system analysis process 290 to typify the system.

During system analysis process 290, a system type for the system may be identified based on the system information. For example, the system information may indicate a deployment type of the system, and the system type may be based in part, on the deployment type. The deployment type may include, for example, a data storage deployment, an artificial intelligence deployment, a three-dimensional (3D) modeling deployment, and/or other types of deployments.

To identify the deployment type for the system, a portion of the system information may be analyzed during system analysis process 290. The deployment type may be associated with the objective for the system. For example, the objective for the system may include provisioning of a computer-implemented service in a desired manner. To meet different objectives, deployments of data processing systems may include different types and/or quantities of hardware and software components conducive to providing the service indicated by the objective in a manner indicated by the objective. Therefore, combinations of (i) different quantities and/or types of hardware components, (ii) different types of software components of the system, and/or (iii) different types of objectives, may be associated with different deployment types.

In a first example, if the objective is to provide efficient access to stored information, the deployment includes a large quantity of storage components (e.g., exceeding a storage capacity threshold) and the system hosts storage and/or networking software, then the deployment type may be likely to be a data storage deployment. In a second example, if the objective is to efficiently perform calculations using complex algorithms, the deployment includes a large quantity of processing units (e.g., exceeding a processing capacity threshold), and the system hosts an artificial intelligence model, then the deployment type may be likely to be an artificial intelligence deployment.

The system may include configurable settings usable to customize operation of the system. A configuration type for the deployment type may be linked to the objective for the system and may be based on the configurable settings. The configuration settings may include any type of configuration settings for the hardware and/or software components of the system, and/or settings that manage interactions between the hardware and/or software components. For example, the configuration settings may include configuration settings for a version of the software. The configuration settings may impact functionality of the software, such as an availability of features of the software to the user of the system.

For example, the configuration settings for the system may include network configuration settings, storage device configuration settings (e.g., data redundancy options), algorithm configuration settings (e.g., parameter definition for an artificial intelligence model), workflow distribution settings, high-performance settings, and/or other types of settings that may impact features of the software available for use by the user. The configuration settings for the software may, for example, indicate features and/or functionality of the software that have been activated, deactivated, and/or modified.

Therefore, during system analysis process 290, to identify features likely to be available for use by the user of the system, a deployment type may be identified, and a configuration type for the deployment type may be identified. The system type may be defined based on a combination of the deployment type and the configuration type.

System analysis process 290 may include any type of analysis process for identifying the system type based on the system information. For example, the system information may be provided to a clustering algorithm to identify a likely deployment type and/or configuration type (e.g., based on large volumes of system information for different systems and their deployment types and/or configuration types). A schema that indicates associations between different portions of system information and system types may be used to identify system type 291 based on the system information. For example, a deployment type and a configuration type may be analyzed using the schema to identify a system type that corresponds to both the deployment type and the configuration type (e.g., system type 291).

Other types of analysis methods may be used to identify system type 291. For example, the system information may be provided as ingest to any number and/or type of inference model(s) trained to identify likely system types based on system information. For example, a classification model may be trained using large volumes of system information for different systems and their associated deployment types, configuration types, and/or system types. The inference model(s) may be used to analyze the system information and output system type 291 and/or other information (e.g., a user type if user information is provided).

System type 291 may be a data structure that includes (i) a system type identifier, (ii) information associated with the system type, such as a list of software features likely to be available to a user of the system, and/or (iii) other information. System type 291 may indicate capabilities (e.g. limits on capabilities) of the system to support features of the software. For example, the software may include features that may be activated or deactivated based on processing, storage, and/or communication capabilities of the system; therefore, system type 291 may be associated with various software features and/or workflows. For example, during system analysis process 290, a schema and/or a trained inference model may be used to associate system type 291 with the list of features of the software that are relevant to system type 291.

System type 291 may be used to identify relevant flow data and/or for other purposes relevant to generation of documentation customized to the system. For example, system type 291 may include information usable to generate a virtual model of the system so that workflows of the software may be simulated. During the simulations, new available content relevant to use of the software when hosted by the system may be automatically generated. Refer to the discussion of FIG. 2D for more details regarding generation of new available content.

Other information types may be identified during system analysis process 290, depending on the use case for the software. For example, if user information for a user of the system is provided to system analysis process 290 (or another process), then a user type for the user may be identified, and the user type may indicate a list of such features that are likely to be accessed by the user while using the software. In some examples, the other types may be provided to flow identification process 292 as indicated by the arrow drawn in dashing.

To obtain the relevant flow data, system type 291 (and/or other types) may be provided to flow identification process 292. During flow identification process 292, system type 291 may be used to identify the relevant flow data from a subset of data sources 100 (e.g., software development elements 220). The relevant flow data may include information regarding features and/or flows of the software likely to be available for use by (e.g., likely to be accessed by) the user of the system. In other words, system type 291 may be used to constrain the relevant flow data to flows and/or features relevant to use of the software when hosted by the system. In an example when a user type is provided to flow identification process 292 (e.g., as a portion of the other types), the user type may be used to (further) constrain the relevant flow data to features and/or flows likely to be relevant to the user of the system, and/or other aspects of the use case.

The relevant flow data may include flows (e.g., workflows of the software), sub-flows, and/or flow steps associated with capabilities and/or objectives of the system, as indicated by system type 291. In other words, the relevant flow data may include information (e.g., topics, scenarios) likely to be relevant to a user of the system based on system type 291.

In a first example, if system type 291 indicates that “software module A” is likely (e.g., above a likelihood threshold) to be available for use by the user, then the relevant flow data may include a list of features of software module A and/or a list of flows associated with software module A. In a second example, if system type 291 indicates that “feature A” is likely to be available for use by the user, then the relevant flow data may include a list of other features associated with feature A and/or flows associated with feature A.

Thus, during flow identification process 292, the relevant flow data may be obtained based at least, on system type 291. The relevant flow data may include, for example, lists of flows, sub-flows, and/or flow steps related to different users and/or different accessibility preferences, identified using information from the software development elements of data sources 100. For example, (i) system level test code may be used to identify system flows associated with system type 291, (ii) portions of test code such as test names and/or test assertions may be used to identify flow steps associated with system type 291, and/or (ii) test run artifacts such as test reports may be used to identify flows, sub-flows, and/or flow steps associated with system type 291.

During flow identification process 292, relevant flow data may be obtained for any number of different system types and/or other types. For example, relevant flow data for multiple system types may be obtained and stored (e.g., as data structures) in relevant flow repository 294. Relevant flow repository 294 may provide storage and/or data management services for the relevant flow data. Relevant flow repository 294 may store any quantity of relevant flow data sets, each of the relevant flow data sets being associated with different system types (and/or other types). Relevant flow repository 294 may include functionality for providing relevant flow data to various processes. For example, a database for relevant flow repository 294 may be queried using a system type identifier and/or other information (e.g., a user type identifier), and the query may return relevant flow data associated with the system type and/or the other information.

The relevant flow data may be used in subsequent processes to customize software documentation (e.g., to a system, to a user of the system, to a locale for the software). For example, the relevant flow data may be used (i) to identify a portion of available content of the software development elements that is relevant to the system (e.g., relevant to features and/or flows of the software that are likely to be available when the software is hosted by the system) during a data source identification process such as data source identification process 240 of FIG. 2D, and/or (ii) to define a document structure for documentation for the system during a structure definition process such as structure definition process 280 of FIG. 2F.

Returning to FIG. 2A and continuing the discussion of content identification process 200, to obtain the available content (e.g., available content 236), (i) software development elements used to produce the software (e.g., software development elements 220) may be identified from data sources 100, (ii) the available content may be identified from the software development elements, and/or (iii) the available content may be extracted from the software development elements. Content identification process 200 may be described in further detail with respect to FIGS. 2D-2E.

Turning to FIG. 2D, a fourth data flow diagram in accordance with an embodiment is shown. The fourth data flow diagram may illustrate data used in and data processing performed when identifying software development elements used to produce software. For example, FIG. 2D may be an expansion of content identification process 200 of FIG. 2A.

To identify the software development elements, data source identification process 240 may be performed. Data source identification process 240 may be initiated based on generation event 201. During data source identification process 240, an entity may be prompted to provide identification data 242 based on information included in generation event 201 (e.g., a software identifier).

For example, the entity may be prompted to provide information regarding software development elements used to produce the software. The entity may include a user and identification data 242 may be obtained based on input from the user, and/or the entity may include a computer and identification data 242 may be automatically generated as part of another process. For example, upon creation of a specific type of file or directory, such as a testing directory, a document policy may be triggered to provide a notification to data source identification process 240.

Identification data 242 may include information usable to identify the software development elements. For example, identification data 242 may include (i) identifiers (e.g., file identifiers, directory identifiers), (ii) instructions for accessing data (e.g., based on the identifiers), and/or (iii) other information (e.g., other instructions and/or cryptographic data usable to access the software development elements). Identification data 242 may be used during data source identification process 240 to identify the software development elements and/or portions thereof from data sources 100.

To identify the software development elements, any number of typification processes may be performed. To do so, data source identification process 240 may access data from and/or provide data to data sources 100. During data source identification process 240, portions of identification data 242 (e.g., identifiers indicating storage locations) may be enumerated to obtain a list of software development elements. For example, the list of software development elements may include a list of file paths and/or directory paths indicated by identification data 242.

Using the list of software development elements, types of the software development elements may be identified. For example, characteristics of portions of available content stored by the software development elements may be obtained. The characteristics of portions of available content may include, for example, (i) directory and/or file names, (ii) file sizes, (iii) file dependencies, (iv) file extension types, (v) file contents (e.g., parsed samples from a header, a footer, and/or a body of a file to identify a format of the file contents), (vi) file metadata, and/or (vii) other measurable or qualitative aspects usable to characterize the portions of available content.

The characteristics of the available content stored by different software development elements may indicate types of the different software development elements, and the types of the software development elements may correspond to phases of a development process for the software. For example, a test code file may have a different file extension type than a test plan file, a test plan file may have a different file content format than an issue tracking data file, and a test run artifact file may have a different file size than a test plan file.

The portions of available content stored by each of the software development elements may be further typified. For example, subtypes of sub-portions of the data may be identified based on the types of the software development elements and characteristics of the sub-portions. The subtypes may indicate different types of available content within each type of software development element. For example, test run artifacts (e.g. a type of software development element) may include subtypes such as test reports and/or test logs.

The available content stored by the software development elements may be typified to any level of detail during data source identification process 240. During data source identification process 240, the types and/or the subtypes may be used to obtain content identifiers 244 and/or extraction processes 246.

Content identifiers 244 may indicate storage locations of information usable to obtain available content from the software development elements. Content identifiers 244 may be defined based on the types and/or the subtypes of the available content. For example, content identifiers 244 may point to the portions of the available content (e.g., defined based on the types) and/or the sub-portions of the available content (e.g., defined based on the subtypes). Content identifiers 244 may include elements such as a directory path, a file path, an offset or byte position within a file, and/or combinations thereof. Content identifiers 244 may include information regarding the types and/or the subtypes of the available content. For example, each of the elements of content identifiers 244 may be tagged with a type, a subtype, and/or other information (e.g., an extraction process identifier).

In some examples, content identifiers 244 may be limited (e.g., filtered, selected) based on relevant flow data from relevant flow repository 294. Therefore, during data source identification process 240, information from generation event 201 and/or system type 291 may be used to query a database for relevant flow repository 294. For example, system type 291 may include a system type identifier and/or generation event 201 may include other information, such as information regarding a user of the software (e.g., a user type identifier), and the identifiers may be used to query the database. In response to the query, the database may return the relevant flow data associated with the system type and/or other information (e.g., the user type).

The relevant flow data may include flow identifiers, feature identifiers, and/or other information usable to limit available content indicated by content identifiers 244. For example, when the software is hosted by a system of system type 291, the relevant flow data may indicate a first set of features of the software likely to be available for use by the user of the system. A second set of features of the software not likely to be available for use by the user of the system may not be included in the relevant flow data. Thus, based on the relevant flow data, content identifiers 244 may be limited so that the portion of available content indicated by content identifiers 244 excludes a second portion of the available content associated with the second set of unlikely features of the software and not associated with the first set of likely features.

Consider an example where the software includes graphics processing unit (GPU) accelerated features. System type 291 may indicate that the system does not include sufficient hardware to support the GPU-accelerated features and/or the system may not be configured appropriately to support the GPU-accelerated features (e.g., as indicated by system type 291). Therefore, the relevant flow data may exclude the GPU-accelerated features, and available content regarding the GPU-accelerated features may be excluded from the portion of the available content indicated by content identifiers 244.

The relevant flow data may be used to limit content identifiers 244 in any other capacity. For example, if the relevant flow data is associated with a user type for a user of the system, then the relevant flow data may indicate features of the software that are likely (or unlikely) to be accessed by the user (e.g., based on a likelihood threshold). Therefore, only available content associated with the features likely to be accessed by the user may be indicated by content identifiers 244.

Extraction processes 246 may include any number and/or type of processes for obtaining available content indicated by content identifiers 244. Extraction processes 246 may be identified based on the types and/or the subtypes of the available content of the software development elements. For example, extraction processes 246 may include sets of instructions that correspond to content identifiers 244. In other words, extraction processes 246 may include customized processes for extracting relevant information from the software development elements depending on the type and/or the subtype of the available content.

For example, extraction processes 246 may include scanning processes (e.g., to scan a directory location related to a file or directory path indicated by content identifiers 244) to identify relevant content, parsing processes (e.g., to identify and/or extract portions of files indicated by content identifiers 244), execution processes (e.g., to execute code and/or other processes to capture visual information during user flow simulations), data transformation processes (e.g., for deriving new data based on data indicated by content identifiers 244), and/or storage processes (e.g., for organizing and/or storing extracted content).

In a first example, content identifiers 244 may point to API information included in production code for the software. Extraction processes 246 may include an extraction process that corresponds to a “production code API information” subtype. For example, extraction processes 246 may include instructions for reading the API information from the production code at a specific byte location in a production code file.

In a second example, content identifiers 244 may point to an image included in test run artifacts for the software. Extraction processes 246 may include an extraction process that corresponds to a “test run artifact image” subtype. For example, extraction processes 246 may include instructions for reading the image file, and transforming the image by compressing the image, adding text to the image (e.g., a title, a watermark), updating metadata for the image, etc.

In a third example, content identifiers 244 may point to a portion of test code for the software. Extraction processes 246 may include an execution process to execute the test code, which may simulate a user flow of the software. Extraction processes 246 may also include a recording process to capture video of a user interface of the software during the simulation and/or an image capturing process to capture images of the user interface at various points during the simulation. By doing so, new available content may be automatically generated based on pre-existing information (e.g., available content) of the software development elements.

To automatically generate the new available content, extraction processes 246 may include processes for modifying portions (e.g., variables) of the test code in order to customize the user interface during the simulation. In a first example, system configuration settings, locale settings, modes of operation (e.g., feature flag settings), and/or other settings that impact the user interface may be modified prior to execution of the test code. The new available content automatically generated upon execution of the test code may be relevant to a user of a system of system type 291.

In a second example, extraction processes 246 may include processes to simulate user flows in different environments (e.g., as when the software is hosted by different types of systems). The test code (and/or the modified test code) may be executed using a virtual model of a target system. For example, a digital twin of the target system may be obtained (e.g., modeled based on information associated with system type 291) and the test code may be executed using the digital twin. For example, new available content may be generated in the context of workflow management, data extraction, and/or other parameters specific to the target system. By doing so, the new available content may be automatically generated upon execution of the test code using the digital twin and may be likely to be relevant to users of the system.

Content identifiers 244 and/or extraction processes 246 may be used to obtain the available content (e.g., the portion of the available content relevant to system type 291). For example, any number of extraction processes 246 corresponding to (elements of) content identifiers 244 may be performed to obtain portions of available content. Thus, the available content used to generate the documentation (e.g., available content 236) may include a subset of available content of data sources 100 and/or new available content generated during the performance of any of extraction processes 246. An example of using content identifiers 244 and extraction process 246 to obtain available content is provided with respect to FIG. 2E.

Turning to FIG. 2E, a fifth data flow diagram in accordance with an embodiment is shown. The fifth data flow diagram may illustrate data used in and data processing performed when identifying and/or obtaining available content from software development elements. For example, FIG. 2E may be an expansion of content identification process 200 of FIG. 2A, where available content (e.g., a portion of the available content relevant to a system hosting the software) is identified.

To obtain the available content from the software development elements, a portion of information from content identifiers 244, such as a file identifier (and related information) may be provided to content classification process 262. The file identifier may, for example, indicate a portion of the software development elements. During content classification process 262, one or more classifications for the portion of the software development elements indicated by the file identifier may be obtained (e.g., classifications 264). Classifications 264 may indicate an expected type of content that is to be extracted from data sources 100 using the file identifier, and therefore may be used to identify a suitable extraction process for doing so.

To obtain classifications 264, a type for the portion of the software development elements (e.g., indicated by the file identifier) may be obtained. The type may include a type and/or a subtype (e.g., obtained during data source identification process 240 of FIG. 2D); therefore, the type may be obtained from information related to the file identifier (e.g., data tags, other information included in content identifiers 244). Classifications 264 may be selected based on the type, for example, using a predetermined classification schema.

The classification schema may include, for example, classes for portions of test code such as (i) system test code (e.g., for system level test code), (ii) integration test code (e.g., for integration level test code), (iii) component test code (e.g., for component level test code), (iv) unit test code (e.g., for unit level test code), (v) test initialization information (e.g., for initialization code), (vi) test assertions (e.g., for Boolean-valued functions in the test code), (v) test names (e.g., for test code file names, for portions of header comments in the test code), and/or (vi) other test code classes.

The classification schema may include, for example, classes for portions of software product integrated organizational information (e.g., structure data) such as user interface menus and/or other software product integrated organizational information classes. For example, the user interface menus class may include information such as menu labels, menu options or commands (e.g., indicating functions of the software), and/or other information for guiding user interactions with the software (e.g., hotkeys, menu icons).

The classification schema may include, for example, classes for portions of code development organizational information (e.g., structure data) such as (i) directory names (and/or metadata), (ii) file names (and/or metadata), (iii) storage structure information (e.g., directory and/or file relationships such as hierarchies), and/or (iv) other code development organizational information classes.

The classification schema may include, for example, classes for portions of artifacts produced during testing of the software (e.g., test run artifacts) such as (i) test logs (e.g., for error information, visual information), (ii) test reports (e.g., for results of good or bad tests with supporting visual information), and/or (iii) other test run artifacts classes. The classification schema may include other classes for other types for the portions of the software development elements.

During content classification process 262, any technique or combination of techniques may be used to obtain classifications 264. In a first example, syntactic analysis techniques (e.g., using natural language processing (NLP) algorithms) may be used to characterize the portion of the software development elements indicated by the file identifier, and classifications 264 may be selected based on the characteristic(s). In a second example, an artificial intelligence model trained to classify portions of software development elements based on content identifiers 244 may be used to obtain classifications 264.

Classifications 264 may include classifications for portions of the software development elements and/or information from content identifiers 244. Classifications 264 may be provided to content extraction process 268 to obtain (e.g., extract) the available content from data sources 100 (e.g., the software development elements). During content extraction process 268, classifications 264 may be used to identify at least one extraction process of extraction processes 246. For example, extraction processes 246 may be keyed to different classes of portions of the software development elements.

During content extraction process 268, at least one extraction process may be performed to obtain extracted content 270 (e.g., a portion of available content 236). For example, during content extraction process 268, an extraction process suitable for obtaining a portion of available content indicated by classifications 264 may be selected from extraction processes 246 based on classifications 264.

Extraction processes 246 may include modifiable code. For example, during content extraction process 268, portions of code of the selected extraction process may be modified (e.g., code parameters may be populated using information included in classifications 264, such as the file identifier and/or the classification). For example, the selected extraction process may call on different processes for extracting available content based on the populated parameters. The modified code may be executed to obtain extracted content 270.

Any method of extraction may be used during content extraction process 268. For example, extraction processes 246 may include (i) natural language processing algorithms (e.g., syntactic analysis), (ii) large language models (LLM) analysis, and/or (iii) other analysis methods or combinations thereof. Therefore, to perform the at least one extraction process, a prompt may be provided to an inference model (e.g., an LLM, an NLP algorithm, and/or other type of model trained to extract available content) to obtain extracted content 270.

For example, the prompt may be provided to content extraction process 268 by an entity such as a user or a computer. The prompt may include information from classifications 264 (e.g., including content identifiers 244), and/or other information. For example, the prompt may include (i) a task such as, “Summarize topics that were tested in the provided test plan directory.”, and context, such as (ii) the provided test plan directory (e.g., from content identifiers 244), and/or (iii) classifications for information included in the provided directory (e.g., from classifications 264). The inference model may use the prompt to obtain extracted content 270 (e.g., a list of topics) from a subset of data sources 100.

Any portion(s) of the procedure described with respect to FIG. 2E may be repeated until all data sources (e.g., software development elements) indicated by content identifiers 244 are subject to content extraction process 268. Portions of extracted content 270 obtained during each iteration of content extraction process 268 may be packaged as the available content used for generating documentation for the software (e.g., available content 236 of FIG. 2B, the available content indicated as obtained during content identification process 200 of FIG. 2A).

Returning to FIG. 2A, the available content may be provided to document population process 202 to obtain documentation 206 (e.g., the software documentation). To perform documentation population process 202, a structure (e.g., defined by document structure data 204) may be identified based at least on the available content. For example, document structure data 204 may include a document skeleton and/or may be generated dynamically based on the available content, information included in generation event 201, and/or other information (e.g., a document objective, relevant flow data).

For example, document structure data 204 may be defined based on relevant flow data for a system type of documentation 206 (e.g., the system type may indicate which feature flags are enabled or disabled); therefore, information included in document structure data 204 may be used to customize documentation 206 to the system. Refer to the discussion of FIG. 2F for more details regarding obtaining document structure data.

During documentation population process 202, documentation 206 may be automatically generated using document structure data 204 and the available content. To customize documentation 206 with respect to a system hosting the software, a user of the system, and/or other subject related to use of the software, the available content input to documentation population process 202 may be based on relevant flow data.

During documentation population process 202, the available content may be used to populate a document structure defined by document structure data 204. For example, placeholders (e.g., for sections and/or sub-sections of documentation 206) defined by document structure data 204 may be populated with corresponding portions of the available content to obtain documentation 206. The portions of the available content may include sections, sub-sections, and/or content for the sections and/or sub-sections.

Consider an example where the available content includes a testing schema defined by the software development elements (e.g., test plans), results of tests outlined by the testing schema, test code used to execute the tests, etc. The testing schema may define system level testing for the software (e.g., using system level test code), integration testing for the software (e.g., using integration level test code), component testing for the software (e.g., using component level test code), unit testing for the software (e.g., using unit level test code), and/or other types of testing of the software (e.g., API testing, load testing, performance testing).

To obtain documentation 206, sections of documentation 206 may be established based on the testing schema. For example, general functionality of the software may be inferred based on the testing schema and/or other information in the available content, and the sections of documentation 206 may be created corresponding to each type of general functionality. The sections may then be populated using other information included the available content that corresponds to each of the sections (e.g., each type of general functionality), such as specific features or functions indicated by the test results and/or the test code.

Documentation 206 may include any type of documentation that supports the software, such as instructions, general information, and/or other materials. For example, documentation 206 may include any and/or combinations of: user manuals, administrator manuals, troubleshooting manuals, system manuals, initial set up guides, frequently asked questions (FAQs), walkthroughs, tutorials, how-to guides, etc. Documentation 206 may include text, images, video, diagrams, and/or other types of information (e.g., referential information such as human interpretable and/or machine-readable links).

Documentation 206 may include human-interpretable instructions (e.g., text-based instructions and/or graphics-based instructions that are decipherable by a human) for performing sets of operations to access different features and/or functionality of the software. For example, if a user desires to accomplish a goal using the software, the user may use documentation 206 to identify an example workflow of a set of operations associated with accomplishment of the goal, and the user may perform the set of operations while operating an instance of the software.

When documentation 206 is customized documentation, documentation 206 may include information relevant to a system type for a system hosting an instance of the software. For example, the information included in documentation 206 may be relevant to a use case for the software defined by capabilities of the host system and the instance of the software (e.g., a version and/or configuration settings of the instance of the software).

Documentation 206 may be provided to documentation repository 207. Documentation repository 207 may provide storage and/or data management services for documentation. Documentation repository 207 may store any quantity of documentation, and different portions of the documentation (e.g., different documents) may be associated with different system types, user types, and/or other types.

Documentation repository 207 may include functionality for providing documentation to various processes. For example, a database for documentation repository 207 may be queried using a system type identifier and/or other information, and the query may return documentation associated with the system type and/or the other information. The documentation may be used to provide support services for users of the software. For example, information in the documentation, such as human interpretable instructions describing workflows, may be used to generate computer instructions to guide the user in completing the workflows.

Documentation 206 may be provided to downstream processes 208. Downstream processes 208 may include any type of processes related to use of documentation 206 and/or provisioning of documentation 206 to downstream consumers. For example, during downstream processes 208, documentation 206 may be provided to users of the software (e.g., beta testers, regular users, devices, and/or other entities with interest in the software) to facilitate different types of software deployment processes, to facilitate provisioning of computer-implemented services via the software, and/or for use in further developing the software (and/or other software).

Downstream processes 208 may include processes for providing support services to downstream consumers of the software. For example, information from documentation 206 may be used to automatically respond to requests for support from users of the software. Downstream processes 208 may include processes for generating computer instructions usable to facilitate interactive support services for the downstream consumers. Refer to the discussion of FIG. 2G for an example of providing support services based on documentation.

Thus, using data flows shown in FIG. 2A, software documentation may be automatically generated and/or customized using available content and document structure data indicating a structure for the software documentation.

Turning to FIG. 2F, a sixth data flow diagram in accordance with an embodiment is shown. The sixth data flow diagram may illustrate data used in and data processing performed when obtaining a structure for documentation. For example, FIG. 2F may illustrate data used in and data processing performed to obtain document structure data 204 of FIG. 2A.

To obtain the structure (e.g., document structure data 204), structure definition process 280 may be performed. During structure definition process 280, available content classified as organizational information may be obtained from available content 236. To do so, a first portion of available content 236 classified as organizational information may be discriminated from a remaining portion of available content 236 that is classified as actionable information.

For example, portions of available content 236 may be classified during a process similar to content classification process 262 of FIG. 2E, and the portions of available content 236 may include information regarding their classification(s). The classifications may be used to discriminate the first portion from the remaining portion.

The portion of available content 236 classified as organizational information may include, for example, code development organizational information and/or software product integrated organizational information; and the remaining portion of available content 236 classified as actionable information may include, for example, software development goal information, production code for the software, test code used to test the software, test plans defining how the software is to be tested, and/or artifacts produced during testing of the software using the test code and the test plans.

The structure may be dynamically defined based on document objective 284 and/or other information, such as relevant flow data from relevant flow repository 294. Note that in some examples, document objective 284 and/or relevant flow data may not be used to dynamically define the structure, as indicated by the arrows drawn in dashing.

Document objective 284 may include any type of objective for the documentation. For example, document objective 284 may be included in a data structure obtained based on an occurrence of a documentation generation event such as generation event 201, and/or may be provided to structure definition process 280 as part of other information (e.g., from a user or other entity, as output from another process). Document objective 284 may be based on (e.g., and/or may include) (i) system information for a system to host the software (e.g., a system type), (ii) user information for a user of the system (e.g., a user type), (iii) a type of documentation that is to be generated (e.g., a document type), and/or (iv) other information (e.g., other types).

For example, the system information may be used to identify a system type for the documentation (e.g., using a schema for typifying systems). The system type may be associated with structural information regarding the documentation and may be used to define portions of document structure data 204. For example, the system type may indicate capabilities and/or objectives of the system with respect to relevant features, topics, and/or scenarios for which sections and/or sub-sections are included in the documentation. For example, sections (or sub-sections) for irrelevant features, topics, and/or scenarios may be excluded from the documentation.

Other information, such as a user type (e.g., defining a level of proficiency of the user, an access level of the user) may be used to define which topic or scenario sections are included in (or excluded from) the documentation. For example, the user type may indicate a level of technical discussion of the topics in the documentation, which may define the topic sections for the documentation.

During structure definition process 280, relevant flow data may be obtained from relevant flow repository 294. For example, a database query may be generated based on the system type, the user type, and/or other information, and the relevant flow data associated with the query may be returned. The relevant flow data may indicate features, topics, and/or scenarios for which sections and/or sub-sections are included in (or excluded from) the documentation.

The type of documentation to be generated may include at least one of, for example, (i) a topic-based document, (ii) a scenario-based document, (iii) a FAQ document, (iv) a trouble-shooting document, and/or (v) other document types. For example, document objective 284 may include a document type identifier, and the document type identifier may be used to identify a document skeleton suitable for use in defining the structure.

During structure definition process 280, a document skeleton may be obtained from document skeleton repository 282. Document skeleton repository 282 may include any number and/or type of document skeletons usable to generate documentation. The document skeletons stored by document skeleton repository 282 may be adapted to define portions of the structure based on the organizational information.

Document skeleton repository 282 may include generalized templates for various types of documentation. During structure definition process 280, a document skeleton may be selected from document skeleton repository 282 based on document objective 284. For example, document skeleton repository 282 may be queried using a system type identifier and a document type identifier, and the document skeleton associated with the query may be returned. The selected document skeleton may be congruent with the system type and may include any number of empty fields intended to be populated with portions of the organizational information and/or information from document objective 284.

For example, if document objective 284 indicates a FAQ document is to be generated, then a document skeleton associated with a FAQ document type may be selected. The selected document skeleton may be generally formatted (e.g., including a cover page, a title, product logos, other information), and may include a defined section for question-and-answer pairs. The defined section for question-and-answer pairs may include a placeholder for more detailed structural information that may be defined using the organizational information. For example, the organizational information may be used to define topic-based subsections for the question-and-answer pairs, an order of the subsections, etc.

The organizational information used to populate placeholders of the document skeleton may be limited based on the relevant flow data. For example, a portion of the organizational information may be selected from available content 236 using flow and/or feature identifiers of the relevant flow data. For example, only organizational information associated with a list of flows, sub-flows, and/or flow steps specified by (e.g., associated with) the relevant flow data may be used to populate the document skeleton (e.g., the placeholders). By doing so, sections defined by document structure data 204 may be more likely to be relevant to document objective 284 (e.g., the system type), thereby reducing a likelihood of information bloat in the documentation.

Thus, during structure definition process 280, the document skeleton may be populated with the (relevant) portion of the organizational information to obtain a portion of the structure (e.g., a portion not already defined by the document skeleton). Information regarding portions of the structure (e.g., the document skeleton populated with portions of the organizational information) may be packaged as document structure data 204. Document structure data 204 may include information regarding a dynamically derived structure for the documentation. Document structure data 204 may be used in subsequent processes (e.g., document population process 202 of FIG. 2A) to obtain the documentation.

Turning to FIG. 2G, a seventh data flow diagram in accordance with an embodiment is shown. The seventh data flow diagram may illustrate data used in and data processing performed when providing documentation-based software support services.

To initiate the support services, a connection between a system hosting an instance of the software, such as downstream system 102A, and a backend service adapted to provide interactive support services may be established. The connection may be established automatically (e.g., upon execution of the instance of the software by downstream system 102A) and/or manually (e.g., by a user of downstream system 102A, by another entity).

Downstream system 102A may be one of downstream consumers 102 of FIG. 1. For example, downstream system 102A may include a downstream consumer of computer-implemented services provided via the software, and therefore may host an instance of the software.

To provide the support services, support initiation process 210 may be performed. During support initiation process 210, downstream system 102A may be automatically identified. Downstream system 102A may be automatically identified based information used to establish and/or maintain the connection, such as an IP address, a MAC address, a system identifier, identifiers for the software, licensing information for the software, and/or other information. Upon identifying downstream system 102A, a system type identifier and/or other identifiers (e.g., a user type identifier, identifiers for the instance of the software) may be obtained. Refer to the discussion of FIG. 2C regarding typification of systems.

During support initiation process 210, a request may be obtained from downstream system 102A. The request may indicate a goal of a user of the instance of the software that the user is unable to accomplish. The request may include system information (e.g., indicating a system type), user information (e.g., user credentials, other user information indicating a user type), state information, and/or other information. The state information may include information regarding preceding system events and/or user interactions, stored variables, and/or other information indicating operation of the system prior to generation of the request.

For example, prior to the generation of the request, the user may initiate a help mode via a user interface of the software. While in the help mode, the user may indicate (e.g., use a cursor to point to, highlight, and/or otherwise select) a user interface element (e.g., an icon, a menu item) that corresponds to a feature of the software. Therefore, the state information may include the indicated user interface element and/or a corresponding feature identifier.

To process the request, the goal of the user may be identified. The goal may include a desired outcome of the user while using the instance of the software (e.g., generating a report using the instance of the software, manipulating user data using the instance of the software). During support initiation process 210, any technique for identifying the goal based on information in the request may be performed. For example, the goal may be identified using a rule-based method or a schema that defines associations between feature identifiers and goals of the user and/or an inference model trained to predict goals (e.g., likely goals) based on feature identifiers. The goal may include one or more potential goals of the user, and an identifier for the goal (e.g., identifiers for each potential goal) may be assigned.

During support initiation process 210, features workflows, and/or other information associated with accomplishment of the goal may be identified. For example, the related features, workflows, and/or other information may be identified using a rule-based method and/or a trained inference model. Identifiers may be assigned to the related features, workflows, and/or other information. The identifiers obtained during support initiation process 210 may include identifiers usable to (i) identify documentation (e.g., customized documentation) relevant to providing support to the user of the instance of the software, and/or (ii) identify a portion of the documentation relevant to accomplishment of the goal.

For example, the identifiers may include (i) system identifiers (e.g., a system type identifier), (ii) identifiers for the instance of the software (e.g., a version identifier, configuration setting identifiers), (iii) an identifier for the user (e.g., a user type identifier), (iv) identifiers for the goal of the user, and/or (v) identifiers for features workflows, and/or other information of the software associated with accomplishment of the goal. The identifiers may be provided to iterative support process 214, where they may be used to facilitate support services to the user of the instance of the software.

To support the user in accomplishing the goal, iterative support process 214 may be performed. During iterative support process 214, documentation (e.g., documentation 206) for the instance of the software may be identified based on downstream system 102A. For example, the identified documentation may be customized to downstream system 102A (e.g., customized to a use case for the software). The documentation may be identified by obtaining previously generated documentation and/or by dynamically generating the documentation. Previously generated documentation may be obtained from documentation repository 207.

As discussed with respect to FIG. 2A, documentation repository 207 may manage previously generated documentation (e.g., documentation generated prior to obtaining the request). During iterative support process 214, a database managing documentation repository 207 may be queried based on identifying information for downstream system 102A. For example, at least a portion of the identifiers from support initiation process 210 (e.g., the system identifier, the identifiers for the instance of the software) may be used to query the database. Documentation repository 207 may return previously generated documentation relevant to the query (e.g., documentation customized to downstream system 102A and/or the use case), such as documentation 206.

However, if previously generated documentation relevant to the query is not available, then documentation 206 may not be obtained from documentation repository 207, as indicated by the arrow drawn in dashing. Instead, documentation 206 may be dynamically generated based on the identifying information for downstream system 102A (e.g., the system type). Refer to the discussion of FIGS. 2A-2F for more information regarding dynamic generation of customized documentation.

During iterative support process 214, a portion of documentation 206 may be identified based at least on the request (e.g., using the identifiers). For example, the portion of documentation 206 may be identified using a portion of the identifiers obtained during support initiation process 210, such as identifiers for the goal of the user and identifiers for features workflows, and/or other information of the software associated with accomplishment of the goal. Any technique for identifying the portion of documentation 206 that is likely to be relevant to accomplishment of the goal may be performed.

For example, the identifiers may be used as key words in a search of documentation 206. During the search, positions within documentation 206 (e.g., indexed locations) associated with instances of the key words (e.g., within a matching threshold) may be identified. The distribution of the indexed locations and/or other criteria (e.g., a hit count for each key word, defined sections or sub-sections of documentation 206) may be used to identify a portion of the documentation 206 that is most likely to include information relevant to the accomplishment of the goal.

The portion of documentation 206 may include human interpretable instructions for performing operations to accomplish the goal. During iterative support process 214, a set of operations (e.g., defining a sequence of operations) that must be performed to accomplish the goal may be identified. For example, the set of operations may be a portion of a workflow of the software. Operations of the set of operations may be identified from the human interpretable instructions of the portion of documentation 206 using a parsing technique, a natural language processing (NLP) model, and/or other methods. For example, the set of operations may be a subset of human interpretable instructions of the portion of documentation 206.

To guide the user in performing at least a portion of the set of operations, instructions (e.g., computer instructions) may be obtained. The instructions may be obtained by translating human interpretable text that describes each operation of the set of operations to computer instructions (e.g., using a rule-based method). The instructions may include instructions for enticing the user to perform at least one operation of the set of operations to facilitate accomplishment of the goal.

For example, the instructions may include at least one of (i) modifying an appearance of a user interface element of a user interface of the instance of the software presented to the user of the instance of the software to draw attention of the user to the user interface element, (ii) adding an information element to the user interface to contextualize a function of the user interface element for the user, and/or (iii) activating the function on behalf of the user.

The user interface element may include, for example, a textual element (e.g., text) and/or a graphical element (e.g., an icon, an image). Modifying the appearance of the user interface element may include (i) modifying a style (e.g., a font style), size, and/or color of the user interface element, (ii) animating the user interface element, (iii) highlighting the user interface element (e.g., activating a glow effect for the user interface element, adding a border to the user interface element), and/or (iv) otherwise modifying the user interface element in a manner that is easily identifiable by the user. The appearance of the user interface element may be modified in any manner that helps the user to distinguish between the user interface element and other user interface elements not related to accomplishing the goal.

Adding the information element to the user interface may include adding a textual or graphical element that (i) draws the attention of the user to a user interface element related to the function (e.g., a graphical element such as an arrow pointing to the user interface element), (ii) describes the function, (iii) prepares the user for an outcome of activating the function, and/or (iv) indicates information regarding other goals that may be accomplished using the function. For example, the information element may appear in the user interface to help the user to determine whether the user desires to perform an operation associated with the function.

Activating the function on behalf of the user may include adding a user interface element to present an option for automatically activating the function. For example, the function may be associated with one or more operations of the set of operations, and the user may interact with the user interface element to initiate automatic activation of the one or more operations, or decline automatic activation of the one or more operations.

The instructions (e.g., computer instructions) may be iteratively provided (e.g., to downstream system 102A) based on the set of operations and a state of the instance of the software. For example, as the user interacts the instance of the software, downstream system 102A may be provide state information to iterative support process 214. The state information may indicate preceding user interactions with the instance of the software, and therefore may indicate latest operations performed by the user.

For example, during iterative support process 214, a first state for the instance of the software may be obtained. The first state may indicate that a first operation of the set of operations has been performed by the user. Based on the first operation, a second operation of the set of operations may be identified. For example, the second operation may be identified as a subsequent operation to the first operation (e.g., as defined by the sequenced set of operations) and/or the second operation may be identified as being associated with other information indicated by the first state. To entice the user to perform the second operation, a second instruction associated with the second operation may be provided to downstream system 102A (e.g., an API of downstream system 102A).

If the state information indicates that the user has deviated from performance of the set of operations (e.g., the latest operation performed by the user is not included in the set of operations, or the latest operation was performed out of order), then iterative support process 214 may identify an instruction associated with a current state of downstream system 102A indicated by the state information, and may provide the instruction to downstream system 102A.

If the state information indicates that the set of operations is to be performed automatically on behalf of the user (e.g., based on user input indicated by the state information), then functionality of downstream system 102A may be automatically invoked to cause the set of operations to be completed. For example, instructions (e.g., computer instructions) for performing the set of operations may be obtained (e.g., using rule-based methods), and the instructions may be provided to downstream system 102A.

By providing interactive support customized to the use case of the software, the user of the instance of the software may be more likely to accomplish the goal, and the user may be more likely to be provided with desired computer-implemented services.

Consider an example where the user of downstream system 102A requests guidance using a report generation feature for the instance of the software. During support initiation process 210, and based on the request and/or a use case of the software (e.g., based on system information and/or user information), a (likely) goal of the user may be to generate an inventory report. Therefore, identifiers usable to identify documentation customized to the use case and portions of the customized documentation relevant to generating the inventory report may be obtained.

During iterative support process 214 and based on information included in the portions of the customized documentation, a flow for generating the inventory report may be identified, and instructions to entice the user to perform the flow may be obtained. The flow may include a list of four steps (e.g., the set of operations), and the instructions may include instructions for enticing the user to perform each of the four steps.

The instructions may include an initial set of instructions that may be provided to downstream system 102A, causing the user interface to present the user with an indication of the goal of the flow (e.g., generating the inventory report) and/or the flow (e.g., a summary of the four steps). The user may provide feedback indicating whether the user wishes to proceed with support for generating the inventory report and/or whether the user prefers “walk me through it” support or “do it for me” support.

The user feedback may be included as a portion of the state information of downstream system 102A that is being provided to interactive support process 214. Based on the user feedback, iterative support process 214 may proceed with providing interactive support services to the user. To provide the user with “do it for me” support, instructions for automatically performing the four steps (e.g., the set of operations) may be provided to downstream system 102A (e.g., instructions for invoking functionality of downstream system 102A to perform the set of operations). Subsequent state information provided to iterative support process 214 may indicate that all steps of the flow have been successfully performed, and instructions for presenting confirmation of completion of the flow to the user may be provided to downstream system 102A.

To provide the user with “walk me through it” support, instructions for enticing the user to perform the first step of the flow may be provided to downstream system 102A. For example, the user may be presented with a message such as “left click on this menu item”, and an animated arrow pointing to a menu item of the user interface. The user may perform the first step by left clicking on the indicated menu item, which may cause a dialog box (e.g., presenting a report generation wizard) to appear in the user interface.

As the user interacts with the instance of the software, state information for downstream system 102A may be provided to iterative support process 214; therefore, the state information may indicate that the dialog box has appeared, and that the user has completed the first step successfully. In response, iterative support process 214 may issue instructions (to downstream system 102A) to entice the user to perform the second step. The dialog box may include several options for proceeding with generation of the inventory report, and the user may be presented with an information element describing each of the options and/or recommending one of the options. The user may select the recommended option from the dialog box, and state information indicating the selection and/or a current state of the instance of the software (e.g., the user has been presented with a new dialog box, the existing dialog box has been closed) may be provided to iterative support process 214.

Upon receiving the state information, iterative support process 214 may identify that the second step has been performed successfully by the user, and instructions for enticing the user to perform the third step may be provided to downstream system 102A. For example, the third step may include navigating to a new page of the user interface or activating a new menu item of the user interface. This iterative process may continue for each step of the flow until the user has successfully performed all four steps. When the state information indicates successful completion of the four steps, instructions for presenting confirmation of completion of the flow to the user may be provided to downstream system 102A.

However, if the user elects to end the interactive support services prior to completion of the flow, then the state information provided to iterative support process 214 may indicate the election, and based on the state information iterative support process 214 may cease to provide instructions to downstream system 102A, thereby terminating the support services.

Although the example provided describes a single set of operations that must be performed for accomplishing the goal (e.g., four steps for completion of the flow), it will be appreciated that any number of sets of operations may be identified. For example, multiple sets of operations relating to the accomplishment of a single goal may be identified (e.g., when at least a portion of the operations are dependent on a user selection).

The instructions for enticing the user to perform the set of operations (e.g., provided to downstream system 102A during iterative support process 214) may include any type of instructions related to performance of the set of operations and/or accomplishment of the goal. For example, instructions for updating an information element indicating the user’s progress through the set of operations may be provided to downstream system 102A, and the instructions may be provided based on state information obtained during iterative support process 214.Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using data flows shown in FIGS. 2A-2G, portions of pre-existing information used to produce software may be automatically identified, extracted, and used to populate dynamically defined structures to generate documentation for the software. The documentation may be automatically customized to a system hosting an instance of the software (e.g., a use case for the software) and therefore may be more likely to include relevant information to a user of the instance of the software than generic documentation.

To increase a likelihood of the user being provided with desired computer-implemented services via the instance of the software, the user may be provided with interactive support services upon request. The interactive support services may be provided automatically, based on information included in the customized documentation.

By doing so, interactive user support may be provided automatically, thereby improving the users’ experience with the software, and reducing manual effort and delays associated with manual methods for providing interactive user support.

As discussed above, the components of FIG. 1 may perform various methods to provide computer-implemented services to users of software in a manner that increases a likelihood of the users being provided with desired computer-implemented services. FIGS. 3A-3B illustrate methods that may be performed by the components of FIG. 1. In the diagram discussed below and shown in FIGS. 3A-3B, any of the operations may be omitted, repeated, performed in different orders, and/or performed in parallel with or in a partially overlapping in time manner with other operations.

Turning to FIG. 3A, a flow diagram illustrating a method in accordance with an embodiment is shown. The flow diagram may illustrate various operations performed while providing computer-implemented services using software.

At operation 300, a request indicating a goal of a user of an instance of the software that the user is unable to accomplish may be obtained. The request may be obtained by (i) reading the request (e.g., from storage), (ii) receiving the request (e.g., from a device), and/or (iii) generating the request. For example, the request may be generated based on information obtained from a system hosting the instance of the software (e.g., preceding user interactions with the instance of the software, such as user actions subsequent to initiating a help mode).

At operation 302, a portion of documentation for the instance of the software may be identified. The portion of the documentation may be identified by methods described with respect to support initiation process 210 and/or iterative support process 214 of FIG. 2G and/or other methods.

Identifying the portion of the documentation may include (i) automatically identifying the system hosting the instance of the software based on a connection between the system and a backend service adapted to support the user in accomplishing the goal, and/or (ii) identifying the documentation based on the system.

The system may be automatically identified by (i) reading a data structure (e.g., from storage) indicating the identity of the system, (ii) receiving a notification indicating the identity of the system, (iii) obtaining system information for the system (e.g., during and/or after establishing the connection) and using a portion of the system information to identify the system (e.g., an IP address, a system identifier), and/or (iv) other methods (e.g., methods described with respect to support initiation process 210 of FIG. 2G). Automatically identifying the system may include automatically identifying the instance of the software. Based on the identity of the system, unique identifiers may be assigned to the system and/or the instance of the software.

The documentation may be identified by (i) reading a data structure (e.g., from storage) indicating the documentation, and/or (ii) receiving a notification indicating documentation. For example, the documentation may be identified by providing a query (e.g., based on the unique identifiers for the system and/or the instance of the software) to a database managing a documentation repository, and receiving a response to the query. The response may include, for example, the documentation and/or a storage location of the documentation.

Identifying the portion of the documentation may include (i) obtaining identifiers based at least on the goal, the identifiers indicating at least one feature of the software, and/or (ii) using the identifiers to identify the portion of the documentation.

The identifiers may be obtained by (i) reading the identifiers (e.g., from storage), (ii) receiving the identifiers (e.g., from a device), and/or (iii) generating the identifiers. For example, the identifiers may be generated by (i) identifying the goal of the user, (ii) providing the goal and/or other information to an entity (e.g., a service, a program) responsible for identifying features and/or flows (e.g., workflows) for the software associated with accomplishment of the goal, and/or (ii) using a schema to identify features and/or flows related to accomplishment of the goal and/or the other information. For example, the identifiers may include.

The identifiers may be used to identify the portion of the documentation by (i) reading a data structure (e.g., from storage) indicating the portion of the documentation, (ii) receiving a notification indicating the portion of the documentation, and/or (iii) scanning or searching the documentation based on the identifiers (e.g., a list of features, topics, workflows, and/or other key words) to identify the portion of the documentation that is most likely to be relevant to the identifiers based on a set of criteria (e.g., a number of hits, specific hits, a minimum and/or maximum number of characters). For example, a portion of the documentation that has the highest number of hits with respect to the identifiers may be selected as the portion of the documentation, or a portion of the documentation that has the highest number of hits and that includes a hit for a specific identifier (e.g., the identifier related to the accomplishment of the goal) may be selected as the portion of the documentation.

Identifying the documentation may include at least one of (i) obtaining previously generated documentation (e.g., generated prior to obtaining the request) and/or (ii) dynamically generating the documentation.

For example, the previously generated documentation may be obtained by (i) reading the previously generated documentation (e.g., from storage, from a repository similar to documentation repository 207 of FIG. 2B), and/or (ii) receiving the previously generated documentation (e.g., from a device, such as a device managing documentation repository 207). The previously generated documentation may include dynamically generated documentation, generated at a point in time prior to operation 302.

The documentation may be dynamically generated using the method described with respect to FIG. 3B and/or by other methods.

Turning to FIG. 3B, a second flow diagram illustrating a method in accordance with an embodiment is shown. The second flow diagram may illustrate various operations performed to dynamically generate documentation for software used to provide computer-implemented services. For example, FIG. 3B may be an expansion of operation 302 of FIG. 3A.

At operation 310, software development elements used to produce the software may be identified. The software development elements may be identified by methods described with respect to content identification process 200 of FIG. 2A, data source identification process 240 of FIG. 2C, and/or by other methods.

For example, the software development elements may be identified by (i) reading a data structure (e.g., from storage) including information usable to identify the software development elements, (ii) receiving a notification including information usable to identify the software development elements, (iii) providing a notification indicating the occurrence of the documentation generation event to an entity responsible for identifying the software development elements, and/or (iv) scanning a known (e.g., trusted) data source that stores information used during development of the software for available content based on input from a user, a process, and/or a device.

At operation 312, available content may be identified from the software development elements. The available content may be identified by methods described with respect to content classification process 262 and/or content extraction process 268 of FIG. 2E, and/or by other methods.

For example, the available content may be identified by (i) reading a data structure (e.g., from storage) indicating information usable to identify the available content, (ii) receiving a notification indicating information usable to identify the available content, (iii) receiving the available content, and/or (iv) characterizing and/or classifying data stored by (or as) the software development elements, and using the characterizations and/or classifications to identify and/or obtain the available content.

Identifying the available content may include (i) obtaining a system type for the system, (ii) obtaining relevant flow data based on the system type (and/or other information), (iii) obtaining content identifiers for available content based on the relevant flow data, and/or (iv) identifying extraction processes that correspond to the content identifiers. For example, the content identifiers may indicate a storage location for a portion of the test code, and an extraction process for the portion of the test code may include modification and/or execution of the test code.

The available content may be a portion of available content stored by the software development elements that is relevant to the system type. The portion of the available content may be identified by filtering content identifiers pointing to available content stored by the software development elements using flow and/or feature identifiers of the relevant flow data for the system type.

At operation 314, a structure may be identified based at least on the available content. The structure may be identified by methods described with respect to document population process 202 of FIG. 2A, structure definition process 280 of FIG. 2E, and/or by other methods.

For example, the structure may be identified by (i) reading a data structure (e.g., from storage) indicating information usable to identify the structure, (ii) receiving a notification indicating information usable to identify the structure, (iii) receiving the structure, and/or (iv) generating the structure using a portion of the available content classified as organizational information and/or other information (e.g., a document objective and/or a document skeleton) to define the structure.

At operation 316, the documentation may be automatically generated using the structure and the available content. The documentation may be automatically generated using methods described with respect to document population process 202 of FIG. 2A and/or by other methods. For example, the available content and the structure may be provided to an inference model trained to generate the documentation based on the available content and the structure and/or by other methods that do not require manual intervention by a subject matter expert.

The documentation may be generated by (i) establishing a first plurality of sections of the documentation based on a testing schema defined by the software development elements, (ii) populating the first plurality of sections using, at least, test results extracted from the software development elements, (iii) inferring, based on the testing schema, functions of the software, (iv) creating sections of the first plurality of sections corresponding to the functions, and/or (v) other methods.

The first plurality of sections may be established by (i) obtaining a data structure indicating the sections that are to be established, (ii) identifying scenarios and/or topics tested using the testing schema (e.g., test plans of the software development elements), (iii) populating the documentation with the tested scenarios and/or topics as the first plurality of sections, and/or (iv) generating empty fields (e.g., defining placeholders) for each of the first plurality of sections for population with other information.

The first plurality of sections may be populated by (i) identifying results of the tested scenarios and/or topics from test run artifacts (e.g., test reports, test logs) of the software development elements, (ii) extracting the identified test results from the software development elements, and/or (iii) using the test results to fill the empty fields of each of the first plurality of sections.

The functions of the software may be inferred by (i) identifying functions tested using the testing schema (e.g., test plans of the software development elements), (ii) treating the tested functions as the functions of the software, and/or (iii) providing the testing schema to an inference model trained to infer functions of the software from at least the testing schema.

Sections of the first plurality of sections may be created by (i) obtaining a list of inferred functions of the software, (ii) using the list of the inferred functions of the software to populate placeholders in each section of the first plurality of sections. For example, the sections may include the tested topics and/or scenarios, and the subsections may include information regarding functions or features associated with each of the tested topics and/or scenarios.

The method may end following operation 316.

Thus, via the method shown in and discussed with respect to FIG. 3B, embodiments disclosed herein may facilitate automated generation of documentation (e.g., customized documentation) based on pre-existing data without requiring human intervention, thereby improving the efficiency of documentation generation.

Returning to FIG. 3A, at operation 304, a set of operations that must be performed to accomplish the goal may be identified based on the portion of the documentation. The set of operations may be identified by (i) reading a data structure indicating the set of operations, (ii) receiving a notification indicating the set of operations, (iii) providing the portion of the documentation to an entity (e.g., a service, a program) responsible for identifying one or more discrete operations that must be performed to accomplish the goal based on human interpretable instructions, and/or (iv) parsing, using a syntactic analysis technique, the portion of the documentation to identify one or more discrete operations that must be performed to accomplish the goal. For example, the one or more discrete operations may be ordered and may be treated as the set of operations.

At operation 306, instructions to entice the user to perform at least a portion of the set of operations to facilitate accomplishment of the goal may be iteratively provided based on the set of operations and a state of the instance of the software. The instructions may include computer instructions, and the instructions may be iteratively provided using methods described with respect to iterative support process 214 of FIG. 2G and/or by other methods.

For example, the instructions may be iteratively provided by (i) obtaining a first state for the instance of the software, the first state indicating that a first operation of the set of operations has been performed by the user, (ii) identifying a second operation of the set of operations based on the first operation, and/or (iii) providing a second instruction of the instructions to entice the user to perform the second operation.

The first state may be obtained by (i) reading the first state (e.g., from storage), (ii) receiving the first state (e.g., from the system), and/or (iii) generating the first state. For example, the first state may be generated based on state information obtained from the system (e.g., preceding events or user interactions, stored variables) during an iterative support process. The first state may indicate that the first operation has been performed. For example, the first operation may be included in the preceding user interactions and/or the first state may match (e.g., within a threshold) an expected state associate with performance of the first operation.

The second operation may be identified by (i) reading a data structure indicating the second operation, (ii) receiving a notification indicating the second operation, and/or (iii) identifying a position of the first operation in the set of operations, and treating the subsequent operation in the set of operations as the second operation. The second operation may be used to obtain a second instruction (e.g., a computer instruction for enticing the user to perform the second operation).

The second instruction may be provided via a connection established between the system and the backend support service by (i) transmitting a message (e.g., including the second instruction), (ii) storing the second instruction in a storage with subsequent retrieval by the system, (iii) using a publish-subscribe system where the system subscribes to updates from the backend support service thereby causing a copy of the second instruction to be propagated to the system, and/or (iv) other methods. The user may be enticed to perform the second operation upon execution of the second instruction.

For example, the second instruction may include at least one of (i) modifying an appearance of a user interface element of a user interface of the instance of the software presented to the user of the instance of the software to draw attention of the user to the user interface element, (ii) adding an information element to the user interface to contextualize a function of the user interface element for the user, and/or (iii) activating the function on behalf of the user. The appearance of the user interface element may be modified, the information element may be added to the user interface, and/or the function may be activated by providing the second instruction to an API of the software.

Iteratively providing the instructions may include automatically invoking functionality of a system hosting the instance of the software to cause the set of operations to be completed. For example, the functionality may be automatically invoked by (i) obtaining state information indicating a user selection to automatically perform the set of operations, (ii) including information (e.g., a message, a command) in the instructions indicating that at the a portion of the instructions are to be executed automatically by the system (e.g., either with, or without user confirmation), and/or (ii) providing, via the established connection, the instructions to the API of the system.

The method may end following operation 306.

Thus, as illustrated above, embodiments disclosed herein may provide systems and methods for providing computer-implemented services using software by using customized documentation to provide automated interactive support to users of the software. By automating generation of the customized documentation, time and manual effort expended during the documentation generation process may be reduced.

By providing users of the software with automated interactive support, the users are more likely to obtain timely and reliable support than when relying on manual interactive support methods. As a result, a likelihood of the software facilitating desired computer-implemented services may be increased.

Any of the components illustrated in FIGS. 1-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using software, the method comprising:
obtaining a request, the request indicating a goal of a user of an instance of the software that the user is unable to accomplish;
identifying, based at least on the request, a portion of documentation for the instance of the software;
identifying, based on the portion of the documentation, a set of operations that must be performed to accomplish the goal; and
iteratively providing, based on the set of operations and a state of the instance of the software, instructions to entice the user to perform at least a portion of the set of operations to facilitate accomplishment of the goal.

2. The method of claim 1, wherein identifying the portion of the documentation comprises:
automatically identifying a system hosting the instance of the software based on a connection between the system and a backend service adapted to support the user in accomplishing the goal; and
identifying the documentation based on the system.

3. The method of claim 2, wherein identifying the portion of the documentation further comprises:
obtaining identifiers based at least on the goal, the identifiers indicating at least one feature of the software; and
using the identifiers to identify the portion of the documentation.

4. The method of claim 2, wherein identifying the documentation comprises at least one selected from a list consisting of:
dynamically generating the documentation; and
obtaining previously generated documentation, the previously generated documentation being generated prior to obtaining the request.

5. The method of claim 4, wherein dynamically generating the documentation comprises:
identifying software development elements used to produce the software;
identifying available content from the software development elements;
identifying a structure based at least on the available content; and
automatically generating the documentation using the structure and the available content.

6. The method of claim 5, wherein the software development elements comprise:
software development goal information;
production code for the software;
code development organizational information;
test code used to test the software;
test plans defining how the software is to be tested;
artifacts produced during testing of the software using the test code and the test plans; and
software product integrated organizational information.

7. The method of claim 1, wherein iteratively providing the instructions comprises:
obtaining a first state for the instance of the software, the first state indicating that a first operation of the set of operations has been performed by the user;
identifying a second operation of the set of operations based on the first operation; and
providing a second instruction of the instructions to entice the user to perform the second operation.

8. The method of claim 7, wherein the second instruction comprises at least one of a group consisting of:
modifying an appearance of a user interface element of a user interface of the instance of the software presented to the user of the instance of the software to draw attention of the user to the user interface element;
adding an information element to the user interface to contextualize a function of the user interface element for the user; and
activating the function on behalf of the user.

9. The method of claim 1, wherein iteratively providing the instructions comprises:
automatically invoking functionality of a system hosting the instance of the software to cause the set of operations to be completed.

10. A non-transitory machine-readable medium having instructions stored therein, which when executed by a processor, cause the processor to perform computer operations for providing computer-implemented services using software, the computer operations comprising:
obtaining a request, the request indicating a goal of a user of an instance of the software that the user is unable to accomplish;
identifying, based at least on the request, a portion of documentation for the instance of the software;
identifying, based on the portion of the documentation, a set of operations that must be performed to accomplish the goal; and
iteratively providing, based on the set of operations and a state of the instance of the software, instructions to entice the user to perform at least a portion of the set of operations to facilitate accomplishment of the goal.

11. The non-transitory machine-readable medium of claim 10, wherein identifying the portion of the documentation comprises:
automatically identifying a system hosting the instance of the software based on a connection between the system and a backend service adapted to support the user in accomplishing the goal; and
identifying the documentation based on the system.

12. The non-transitory machine-readable medium of claim 11, wherein identifying the portion of the documentation further comprises:
obtaining identifiers based at least on the goal, the identifiers indicating at least one feature of the software; and
using the identifiers to identify the portion of the documentation.

13. The non-transitory machine-readable medium of claim 11, wherein identifying the documentation comprises at least one selected from a list consisting of:
dynamically generating the documentation; and
obtaining previously generated documentation, the previously generated documentation being generated prior to obtaining the request.

14. The non-transitory machine-readable medium of claim 13, wherein dynamically generating the documentation comprises:
identifying software development elements used to produce the software;
identifying available content from the software development elements;
identifying a structure based at least on the available content; and
automatically generating the documentation using the structure and the available content.

15. The non-transitory machine-readable medium of claim 14, wherein the software development elements comprise:
software development goal information;
production code for the software;
code development organizational information;
test code used to test the software;
test plans defining how the software is to be tested;
artifacts produced during testing of the software using the test code and the test plans; and
software product integrated organizational information.

16. A data processing system, comprising:
a processor; and
a memory coupled to the processor to store computer instructions, which when executed by the processor, cause computer operations for providing computer-implemented services using software to be performed, the computer operations comprising:
obtaining a request, the request indicating a goal of a user of an instance of the software that the user is unable to accomplish,
identifying, based at least on the request, a portion of documentation for the instance of the software,
identifying, based on the portion of the documentation, a set of operations that must be performed to accomplish the goal, and
iteratively providing, based on the set of operations and a state of the instance of the software, instructions to entice the user to perform at least a portion of the set of operations to facilitate accomplishment of the goal.

17. The data processing system of claim 16, wherein identifying the portion of the documentation comprises:
automatically identifying a system hosting the instance of the software based on a connection between the system and a backend service adapted to support the user in accomplishing the goal; and
identifying the documentation based on the system.

18. The data processing system of claim 17, wherein identifying the portion of the documentation further comprises:
obtaining identifiers based at least on the goal, the identifiers indicating at least one feature of the software; and
using the identifiers to identify the portion of the documentation.

19. The data processing system of claim 17, wherein identifying the documentation comprises at least one selected from a list consisting of:
dynamically generating the documentation; and
obtaining previously generated documentation, the previously generated documentation being generated prior to obtaining the request.

20. The data processing system of claim 19, wherein dynamically generating the documentation comprises:
identifying software development elements used to produce the software;
identifying available content from the software development elements;
identifying a structure based at least on the available content; and
automatically generating the documentation using the structure and the available content.
